(19) United States
(12) Patent Application Publication
(10) Pub. No.: US 2023/0354383 A1
(43) Pub. Date: Nov. 2, 2023

(54) GROUPCAST FEEDBACK METHOD, APPARATUS, AND SYSTEM

(71) Applicant: HUAWEI TECHNOLOGIES CO., LTD., Shenzhen (CN)

(72) Inventors: Guangji CHEN, Shenzhen (CN); Bo YANG, Moscow (RU); Yongchao YANG, Nanjing (CN); Chenhe JI, Nanjing (CN)

(21) Appl. No.: 18/348,423

(22) Filed: Jul. 7, 2023

Related U.S. Application Data
(63) Continuation of application No. PCT/CN2021/139821, filed on Dec. 20, 2021.

(30) Foreign Application Priority Data
Jan. 8, 2021 (CN) 202110026480.9

(51) Int. Cl. H04W 72/30; H04L 5/00

(52) U.S. Cl. CPC H04W 72/30; H04L 5/0048

(57) ABSTRACT

This application relates to the field of wireless fidelity Wi-Fi technologies, and in particular, to a groupcast feedback method, an apparatus, and a system, to send a feedback in a groupcast transmission scenario. According to the method, an access point sends a groupcast data frame and a groupcast feedback trigger frame. The groupcast feedback trigger frame is used to schedule a plurality of stations in a groupcast group to indicate whether the groupcast data frame is correctly decoded.

### CROSS-REFERENCE TO RELATED APPLICATIONS

This application is a continuation of International Application No. PCT/CN2021/139821, filed on Dec. 20, 2021, which claims priority to Chinese Patent Application No. 202110026480.9, filed on Jan. 8, 2021. The disclosures of the aforementioned applications are hereby incorporated by reference in their entireties.

### TECHNICAL FIELD

This application relates to the field of wireless fidelity technologies, and in particular, to a groupcast feedback method, an apparatus, and a system.

### BACKGROUND

A typical transmission mode for a wireless local area network (WLAN) is a point-to-point unicast transmission mode. When quality of a radio channel is unstable due to factors such as small-scale fast fading, occlusion and shadow fading, and co-channel interference, an access point (AP) in a unicast transmission mode may obtain a link quality status of the channel based on an acknowledgement feedback of a station (STA), to perform retransmission based on the link quality status or adjust a modulation and coding scheme (MCS), so as to implement rate adaptation.

With rapid development and wide application of WLAN technologies, new services such as video conferencing, virtual reality teaching, and an electronic schoolbag gradually emerge. These services usually have characteristics such as a large capacity and high user density. For such new services, point-to-multipoint groupcast transmission is widely used to improve utilization efficiency of a spectrum resource and relieve a contradiction between a high network throughput performance requirement and a shortage of the spectrum resource.

In a groupcast transmission scenario, quality of a channel may also be unstable. To ensure transmission reliability, the AP may need to perform rate adaptation or retransmission based on a channel quality status. Therefore, a proper feedback mechanism needs to be designed for groupcast transmission, so that the AP obtains the channel quality status.

### SUMMARY

This application provides a groupcast feedback method, an apparatus, and a system, to send a feedback in a groupcast transmission scenario, so that an access point performs retransmission or adjusts a rate based on the feedback, to improve transmission reliability and transmission efficiency.

To achieve the foregoing objective, the following technical solutions are used in this application.

According to a first aspect, a groupcast feedback method is provided. The method may be performed by an access point, or may be performed by a component of the access point, for example, a processor, chip, or chip system of the access point. An example in which the access point performs the method is used for description in this application. The method includes: An access point sends a groupcast data frame and a groupcast feedback trigger frame. The groupcast feedback trigger frame is used to schedule a plurality of stations in a groupcast group to indicate whether the groupcast data frame is correctly decoded. Then, when detecting no energy on a first subcarrier and a second subcarrier, the access point determines that a first station incorrectly decodes the groupcast data frame. Alternatively, when the access point detects energy on a second subcarrier, the access point determines that a first station incorrectly decodes the groupcast data frame. The first subcarrier is a subcarrier associated with the first station in a first subcarrier set. The second subcarrier is a subcarrier associated with the first station in a second subcarrier set. The first station is any one of the plurality of stations.

Based on this solution, the access point schedules a station in the groupcast group to reply with a groupcast feedback report frame, and detect energy on a subcarrier associated with the station, to determine whether the station in the groupcast group correctly decodes the groupcast data frame. Because the access point can determine a station that incorrectly performs decoding and the station that correctly performs decoding in the groupcast group, the access point can retransmit the groupcast data frame to the station that incorrectly performs decoding, to improve transmission reliability, or can adjust a link rate, to improve transmission efficiency.

In some possible designs, when the groupcast data frame is an aggregate-media access control protocol data unit AMPDU, the groupcast feedback method further includes: The access point sends a block acknowledgement request trigger frame. The block acknowledgement request trigger frame is used to schedule at least one second station to feed back, on a resource unit RU associated with the at least one second station, a sequence number index of an incorrectly decoded media access control protocol data unit MPDU in the AMPDU. The second station is a station in the plurality of stations that incorrectly decodes the AMPDU. The access point receives, on the RU associated with the at least one second station, a block acknowledgement frame from the at least one second station. The block acknowledgement frame is used to indicate the incorrectly decoded MPDU in the AMPDU.

Based on this possible design, when the groupcast data frame is the AMPDU, this application provides a two-level feedback mechanism. In the first-level feedback, the access point can first schedule, by using the groupcast feedback trigger frame, a station in the groupcast group to reply with the groupcast feedback report frame. In this way, the access point can learn the station that incorrectly decodes the AMPDU in the groupcast group. In the second-level feedback, the access point schedules, by using the block acknowledgement request trigger frame, the station that incorrectly decodes the AMPDU, to feed back the sequence number index of the incorrectly decoded MPDU. Therefore, the access point can retransmit the incorrectly decoded MPDU to improve transmission reliability, or can adjust the link rate to improve transmission efficiency. In addition, the access point filters out, by using the first-level feedback, a STA that correctly performs decoding. Therefore, in the second-level feedback, an RU can be prevented from being allocated to the STA that correctly performs decoding. This can effectively reduce overheads of interaction between the block acknowledgement request trigger frame and the block acknowledgement frame in the second-level feedback.

A channel bandwidth of 40 MHz is used as an example. It is assumed that the groupcast group includes 60 STAs in total, and there are 18 RUs that can be used to feed back the incorrectly decoded MPDU. Based on a GCR MU-BAR feedback mechanism in the 802.11ax standard, the AP needs to send four MU-BAR trigger frames. Correspondingly, the STAs in the groupcast group need to reply with BA frames regardless of whether the STAs correctly decode the AMPDU. Based on the solution of this application, within a specific PER range, the AP only needs to send two block acknowledgement trigger frames, and a STA that correctly decodes the AMPDU does not need to reply with the BA frame. This reduces transmission overheads of a control frame.

According to a second aspect, a groupcast feedback method is provided. The method may be performed by a first station, or may be performed by a component of the first station, for example, a processor, chip, or chip system of the first station. An example in which the first station performs the method is used for description in this application. The method includes: A first station receives a groupcast data frame and a groupcast feedback trigger frame from an access point. The groupcast feedback trigger frame is used to schedule a plurality of stations in a groupcast group to indicate whether the groupcast data frame is correctly decoded. Then, when determining that the plurality of stations include the first station and the first station incorrectly decodes the groupcast data frame, the first station sends a groupcast feedback report frame to the access point on a second subcarrier. The second subcarrier is a subcarrier associated with the first station in a second subcarrier set.

In some possible designs, when the groupcast data frame is an aggregate-media access control protocol data unit AMPDU, the groupcast feedback method further includes: The first station receives a block acknowledgement request trigger frame from the access point. The block acknowledgement request trigger frame is used to schedule the first station to feed back, on a resource unit RU associated with the first station, a sequence number index of an incorrectly decoded media access control protocol data unit MPDU in the AMPDU. The first station sends, on the RU associated with the first station, a block acknowledgement frame to the access point. The block acknowledgement frame is used to indicate the incorrectly decoded MPDU in the AMPDU.

For technical effect brought by any possible design of the second aspect, refer to technical effect brought by corresponding designs of the first aspect. Details are not described herein again.

With reference to the first aspect or the second aspect, in some possible designs, the groupcast feedback trigger frame includes a third field. The third field indicates a first network allocation vector NAV. Duration of the first NAV is a sum of a plurality of items: duration of the groupcast feedback report frame, duration of the block acknowledgement request trigger frame, duration of the block acknowledgement frame, and a short interframe space SIFS. The groupcast feedback report frame is a response frame of the groupcast feedback trigger frame.

With reference to the first aspect or the second aspect, in some possible designs, the groupcast feedback trigger frame includes a third field. The third field indicates a first network allocation vector NAV. Duration of the first NAV is a sum of duration of the groupcast feedback report frame and a short interframe space SIFS. The groupcast feedback report frame is a response frame of the groupcast feedback trigger frame.

Based on the two possible designs, the access point can indicate the first NAV in the groupcast feedback trigger frame, to protect a channel in a feedback procedure. This reduces interference of a non-groupcast station to the feedback procedure, improves feedback efficiency, and reduces a feedback delay. In this way, the access point can timely retransmit an incorrect MPDU to reduce a groupcast service delay, or can timely adjust a transmission rate to improve a groupcast service transmission rate.

With reference to the first aspect or the second aspect, in some possible designs, the groupcast feedback trigger frame includes a first field. When a value of the first field is a first value, it indicates that a type of the groupcast feedback trigger frame is a groupcast with retries acknowledgement request.

Based on this possible design, the first field is carried in the groupcast feedback trigger frame, so that a station in the groupcast group can determine a type of the groupcast feedback trigger frame, and then can provide a feedback based on the feedback trigger frame.

With reference to the first aspect or the second aspect, in some possible designs, the groupcast feedback trigger frame includes a second field. The second field indicates the groupcast data frame.

Based on this possible design, the second field can be carried in the groupcast feedback trigger frame to explicitly indicate the groupcast data frame, so that a station in the groupcast group can determine whether the groupcast data frame indicated by the groupcast feedback trigger frame is correctly decoded, to feed back the groupcast data frame. In this way, the access point and the station have a consistent understanding of a feedback object, and feedback accuracy is improved.

With reference to the first aspect or the second aspect, in some possible designs, the second field includes a first subfield and a second subfield. The first subfield is used to carry a sequence number index of a start data frame in the groupcast data frame. The second subfield is used to carry a sequence number index of an end data frame in the groupcast data frame.

With reference to the first aspect or the second aspect, in some possible designs, the second field includes a first subfield and a second subfield. The first subfield is used to carry a sequence number index of a start data frame in the groupcast data frame. The second subfield is used to carry a number of data frames included in the groupcast data frame.

With reference to the first aspect or the second aspect, in some possible designs, the second field includes a first subfield and a second subfield. The first subfield is used to carry a number of data frames included in the groupcast data frame. The second subfield is used to carry a sequence number index of an end data frame in the groupcast data frame.

With reference to the first aspect or the second aspect, in some possible designs, the groupcast feedback trigger frame is a null data packet feedback report poll trigger NFRP frame.

According to a third aspect, a groupcast feedback method is provided. The method may be performed by an access point, or may be performed by a component of the access point, for example, a processor, chip, or chip system of the access point. An example in which the access point performs the method is used for description in this application. The method includes: An access point sends a groupcast data frame and a groupcast feedback trigger frame. The groupcast feedback trigger frame is used to configure at least one resource unit RU. The RU is used by a station in a groupcast group to transmit a block acknowledgement frame of the groupcast data frame in an uplink orthogonal frequency division multiple access-based random access UORA process. The access point receives, by using a first RU in the UORA process, the block acknowledgement frame from the first station. The block acknowledgement frame is used to indicate an incorrectly decoded data frame in the groupcast data frame. The first RU is one of at least one RU configured by the groupcast feedback trigger frame.

Based on this solution, in one aspect, the access point preconfigures the at least one RU that is configured to feed back a block acknowledgement frame of a groupcast station that incorrectly performs decoding, to obtain a transmission status of the groupcast data frame. In this way, the access point can retransmit an incorrectly decoded data frame in the groupcast data frame to improve transmission reliability, or adjust a link transmission rate to improve transmission efficiency. In another aspect, in this application, only a block acknowledgement frame of the groupcast station that incorrectly performs decoding is fed back, and a block acknowledgement frame of a groupcast STA that correctly performs decoding may not be fed back. This can reduce transmission overheads of a control frame, compared with a solution according to a conventional GCR MU-BAR feedback method defined in the 802.11ax standard, in which the block acknowledgement frame of the groupcast STA that correctly performs decoding is also fed back.

According to a fourth aspect, a groupcast feedback method is provided. The method may be performed by a first station, or may be performed by a component of the first station, for example, a processor, chip, or chip system of the first station. An example in which the first station performs the method is used for description in this application. The method includes: A first station receives a groupcast data frame and a groupcast feedback trigger frame from an access point. The groupcast feedback trigger frame is used to configure at least one resource unit RU. The RU is used by a station in a groupcast group to perform uplink orthogonal frequency division multiple access-based random access UORA. The UORA is used to transmit a block acknowledgement frame of the groupcast data frame. When the first station incorrectly decodes the groupcast data frame, the first station sends, by using a first RU in the UORA process, the block acknowledgement frame of the groupcast data frame to the access point. The block acknowledgement frame is used to indicate an incorrectly decoded data frame in the groupcast data frame. The first RU is one of the at least one RU configured by the groupcast feedback trigger frame. For technical effect brought by the fourth aspect, refer to technical effect brought by the third aspect. Details are not described herein again.

In some possible designs, that the first station sends, by using a first RU in the UORA process, the block acknowledgement frame of the groupcast data frame to the access point includes: The first station selects a random number from a contention window. When the random number is less than or equal to a total number of the at least one RU configured by the groupcast feedback trigger frame, the first station selects the first RU from the at least one RU, and sends, on the first RU, the block acknowledgement frame of the groupcast data frame to the access point.

With reference to the third aspect or the fourth aspect, in some possible designs, the groupcast data frame is an aggregate-media access control protocol data unit AMPDU, and a data frame is a media access control protocol data unit MPDU.

With reference to the third aspect or the fourth aspect, in some possible designs, the groupcast feedback trigger frame includes a first field. When a value of the first field is a first value, it indicates that a type of the groupcast feedback trigger frame is uplink orthogonal frequency division multiple access-based random access-negative acknowledgement poll.

According to a fifth aspect, a communication apparatus is provided to implement the foregoing methods. The communication apparatus may be the access point in the first aspect or the third aspect, or an apparatus including the access point, or an apparatus included in the access point, for example, a chip. Alternatively, the communication apparatus may be the first station in the second aspect or the fourth aspect, or an apparatus including the first station, or an apparatus included in the first station, for example, a chip. The communication apparatus includes a corresponding module, unit, or means for implementing the foregoing method. The module, unit, or means may be implemented by hardware, software, or hardware executing corresponding software. The hardware or the software includes one or more modules or units corresponding to the foregoing functions.

In some possible designs, the communication apparatus may include a processing module and a transceiver module. The transceiver module may also be referred to as a transceiver unit, and is configured to implement a sending function and/or a receiving function according to any one of the foregoing aspects or the possible implementations of the foregoing aspects. The transceiver module may include a transceiver circuit, a transceiver machine, a transceiver, or a communication interface. The processing module may be configured to implement a processing function according to any one of the foregoing aspects or the possible implementations of the foregoing aspects.

In some possible designs, the transceiver module includes a sending module and a receiving module, respectively configured to implement the sending function and the receiving function according to any one of the foregoing aspects or the possible implementations of the foregoing aspects.

The communication apparatus provided in the fifth aspect is configured to perform any one of the foregoing aspects or the possible implementations of the foregoing aspects. For specific details, refer to any one of the foregoing aspects or the possible implementations of the foregoing aspects. Details are not described herein again.

According to a sixth aspect, a communication apparatus is provided, and includes a processor and a memory. The memory is configured to store computer instructions. When the processor executes the instructions, the communication apparatus is enabled to perform the method according to any one of the foregoing aspects. The communication apparatus may be the access point in the first aspect or the third aspect, or an apparatus including the access point, or an apparatus included in the access point, for example, a chip. Alternatively, the communication apparatus may be the first station in the second aspect or the fourth aspect, or an apparatus including the first station, or an apparatus included in the first station, for example, a chip.

According to a seventh aspect, a communication apparatus is provided. The apparatus includes a processor and a communication interface. The communication interface is configured to communicate with a module other than the communication apparatus, and the processor is configured to execute a computer program or instructions, so that the communication apparatus performs the method according to any one of the foregoing aspects. The communication apparatus may be the access point in the first aspect or the third aspect, or an apparatus including the access point, or an apparatus included in the access point, for example, a chip. Alternatively, the communication apparatus may be the first station in the second aspect or the fourth aspect, or an apparatus including the first station, or an apparatus included in the first station, for example, a chip.

According to an eighth aspect, a communication apparatus is provided. The apparatus includes an interface circuit and a logic circuit. The interface circuit is configured to obtain input information and/or output information. The logic circuit is configured to perform the method according to any one of the foregoing aspects or the possible implementations of the foregoing aspects, to process and/or generate the output information based on the input information. The communication apparatus may be the access point in the first aspect or the third aspect, or an apparatus including the access point, or an apparatus included in the access point, for example, a chip. Alternatively, the communication apparatus may be the first station in the second aspect or the fourth aspect, or an apparatus including the first station, or an apparatus included in the first station, for example, a chip.

The communication apparatus may be the access point in the first aspect, an apparatus including the access point, or an apparatus included in the access point.

In some possible designs, the output information may be a groupcast data frame and a groupcast feedback trigger frame. The groupcast feedback trigger frame is used to schedule a plurality of stations in a groupcast group to indicate whether the groupcast data frame is correctly decoded.

In some possible designs, the input information may be a block acknowledgement frame of at least one second station, and the block acknowledgement frame is used to indicate an incorrectly decoded MPDU in an AMPDU. Correspondingly, performing processing based on the input information may be determining a retransmitted MPDU or modulating a transmission rate based on the block acknowledgement frame.

The communication apparatus may be the first station in the second aspect, an apparatus including the first station, or an apparatus included in the first station.

In some possible designs, the input information may be a groupcast data frame and a groupcast feedback trigger frame. The groupcast feedback trigger frame is used to schedule a plurality of stations in a groupcast group to indicate whether the groupcast data frame is correctly decoded. Correspondingly, performing processing based on the input information may be sending a groupcast feedback report frame to an access point on a second subcarrier when the plurality of stations scheduled by the groupcast feedback trigger frame in the groupcast group include a first station, and the first station incorrectly decodes the groupcast data frame. The second subcarrier is a subcarrier associated with the first station in a second subcarrier set.

In some possible designs, the output information may be a block acknowledgement frame, and the block acknowledgement frame is used to indicate an incorrectly decoded MPDU in an AMPDU.

The communication apparatus may be the access point in the third aspect, an apparatus including the access point, or an apparatus included in the access point.

In some possible designs, the output information may be a groupcast data frame and a groupcast feedback trigger frame. The groupcast feedback trigger frame is used to configure at least one resource unit RU. The RU is used by a station in a groupcast group to transmit a block acknowledgement frame of the groupcast data frame in an uplink orthogonal frequency division multiple access-based random access UORA process.

In some possible designs, the input information may be a block acknowledgement frame, and the block acknowledgement frame is used to indicate an incorrectly decoded data frame in a groupcast data frame. Correspondingly, performing processing based on the input information may be determining a retransmitted data frame or modulating a transmission rate based on the block acknowledgement frame.

The communication apparatus may be the first station in the fourth aspect, an apparatus including the first station, or an apparatus included in the first station

In some possible designs, the input information may be a groupcast data frame and a groupcast feedback trigger frame. The groupcast feedback trigger frame is used to configure at least one resource unit RU. The RU is used by a station in a groupcast group to transmit a block acknowledgement frame of the groupcast data frame in an uplink orthogonal frequency division multiple access-based random access UORA process. Correspondingly, performing processing based on the input information may be: when a first station incorrectly decodes the groupcast data frame, sending, by using a first RU, a block acknowledgement frame of the groupcast data frame to an access point in a UORA process. The block acknowledgement frame is used to indicate an incorrectly decoded data frame in the groupcast data frame. The first RU is one of the at least one RU configured by the groupcast feedback trigger frame.

In some possible designs, the output information may be a block acknowledgement frame, and the block acknowledgement frame is used to indicate an incorrectly decoded data frame in a groupcast data frame.

According to a ninth aspect, a communication apparatus is provided. The apparatus includes at least one processor. The processor is configured to execute a computer program or instructions stored in a memory, so that the communication apparatus performs the method according to any one of the foregoing aspects. The memory may be coupled to the processor, or may be independent of the processor. The communication apparatus may be the access point in the first aspect or the third aspect, or an apparatus including the access point, or an apparatus included in the access point, for example, a chip. Alternatively, the communication apparatus may be the first station in the second aspect or the fourth aspect, or the apparatus including the first station, or the apparatus included in the first station, for example, a chip.

According to a tenth aspect, a computer-readable storage medium is provided. The computer-readable storage medium stores instructions. When the instructions are run on a communication apparatus, the communication apparatus is enabled to perform the method according to any one of the foregoing aspects.

According to an eleventh aspect, a computer program product including instructions is provided. When the computer program product runs on a communication apparatus, the communication apparatus is enabled to perform the method according to any one of the foregoing aspects.

According to a twelfth aspect, a communication apparatus (for example, the communication apparatus may be a chip or a chip system) is provided. The communication apparatus includes a processor, configured to implement a function according to any one of the foregoing aspects.

In some possible designs, the communication apparatus includes a memory, and the memory is configured to store necessary program instructions and data.

In some possible designs, when the apparatus is a chip system, the apparatus may include a chip, or may include a chip and another discrete component.

It may be understood that, when the communication apparatus provided in any one of the fifth aspect to the twelfth aspect is the chip, the foregoing sending action/function may be understood as output information, and the foregoing receiving action/function may be understood as input information.

For technical effect brought by any one of design manners in the fifth aspect to the twelfth aspect, refer to technical effect brought by different design manners of the first aspect, the second aspect, the third aspect, or the fourth aspect. Details are not described herein again.

According to a thirteenth aspect, a communication system is provided. The communication system includes the access point according to the first aspect and the first station according to the second aspect. Alternatively, the communication system includes the access point according to the third aspect and the first station according to the fourth aspect.

### BRIEF DESCRIPTION OF DRAWINGS

FIG. 1 is a schematic diagram of a structure of a communication system according to this application;

FIG. 2 is a diagram of a network architecture of multi-link communication according to this application;

FIG. 3 is a schematic diagram of a structure of a WLAN device according to this application;

FIG. 4 is a schematic diagram of a structure of a user information field in an NFRP frame according to this application;

FIG. 5 is a schematic diagram of a frame structure of an NDP feedback report response frame according to this application;

FIG. 6 is a schematic diagram of setting a network allocation vector NAV according to this application;

FIG. 7a is a schematic diagram of unicast transmission according to this application;

FIG. 7b is a schematic diagram of groupcast transmission according to this application;

FIG. 8 is a schematic flowchart of a BAR frame-based groupcast feedback according to this application;

FIG. 9 is a schematic flowchart of an MU-BAR frame-based groupcast feedback according to this application;

FIG. 10 is a schematic flowchart of a groupcast feedback method according to this application;

FIG. 11a is a schematic diagram of a local frame structure of a groupcast feedback trigger frame according to this application;

FIG. 11b is a schematic diagram of a local frame structure of another groupcast feedback trigger frame according to this application;

FIG. 12 is a schematic flowchart of another groupcast feedback method according to this application;

FIG. 13 is a schematic diagram of a groupcast feedback procedure according to this application;

FIG. 14 is a sequence diagram of a groupcast feedback according to this application;

FIG. 15 is a schematic diagram of setting a first NAV according to this application;

FIG. 16 is a schematic diagram of setting another first NAV according to this application;

FIG. 17 is a schematic flowchart of still another groupcast feedback method according to this application;

FIG. 18 is a schematic diagram of RU distribution according to this application;

FIG. 19 is a schematic diagram of a local frame structure of still another groupcast feedback trigger frame according to this application;

FIG. 20 is a schematic diagram of another groupcast feedback procedure according to this application;

FIG. 21 is a schematic diagram of a structure of an access point according to an application;

FIG. 22 is a schematic diagram of a structure of a first station according to this application; and

FIG. 23 is a schematic diagram of a structure of a communication apparatus according to this application.

### DESCRIPTION OF EMBODIMENTS

Unless otherwise specified, “/” in the descriptions of this application represents an “or” relationship between associated objects. For example, AB may represent A or B. In this application, “and/or” describes only an association relationship for describing associated objects and represents that three relationships may exist. For example, A and/or B may represent the following three cases: Only A exists, both A and B exist, and only B exists. A and B may be singular or plural. In addition, unless otherwise specified, “a plurality of” in the descriptions of this application means two or more than two. “At least one item (piece) of the following” or a similar expression thereof refers to any combination of these items, including any combination of singular items (pieces) or plural items (pieces). For example, at least one (piece) of a, b, or c may represent: a, b, c, a and b, a and c, b and c, or a, b, and c, where a, b, and c may be singular or plural. In addition, to clearly describe the technical solutions in embodiments of this application, the words such as “first” and “second” are used in embodiments of this application to distinguish between same items or similar items that provide basically same functions or purposes. A person skilled in the art may understand that the words such as “first” and “second” do not constitute a limitation on a number or an execution sequence, and that the words such as “first” and “second” do not indicate a definite difference.

It should be noted that, in this application, the words such as “example” or “for example” is used to represent giving an example, an illustration, or a description. Any embodiment or design scheme described as an “example” or “for example” in this application should not be explained as being more preferred or having more advantages than another embodiment or design scheme. Exactly, use of the words such as “example” or “for example” is intended to present a related concept in a specific manner.

Embodiments of this application are applicable to a wireless local area network (WLAN) scenario, and are applicable to the institute of electrical and electronics engineers (IEEE) 802.11 system standard, for example, the 802.11a/b/g standard, the 802.11n standard, the 802.11ac standard, the 802.11ax standard, or a next-generation standard, for example, the 802.11be standard or a further next-generation standard. Alternatively, embodiments of this application are applicable to a wireless local area network system, for example, an Internet of things (IoT) network or a vehicle to X (V2X) network. It is clear that embodiments of this application are also applicable to another possible communication system, for example, a long term evolution (LTE) system, an LTE frequency division duplex (FDD) system, an LTE time division duplex (TDD) system, a universal mobile telecommunication system (UMTS), a worldwide interoperability for microwave access (WiMAX) communication system, and a 5th generation (5G) communication system.

First, this application provides a WLAN communication system to which an embodiment of this application is applicable. The WLAN communication system includes at least one wireless access point (AP) and a plurality of stations (STAs) associated with the AP. It should be noted that the STA in this embodiment of this application may also be referred to as a terminal, and the STA and the terminal may be replaced with each other. This is not specifically limited in the method provided in this application.

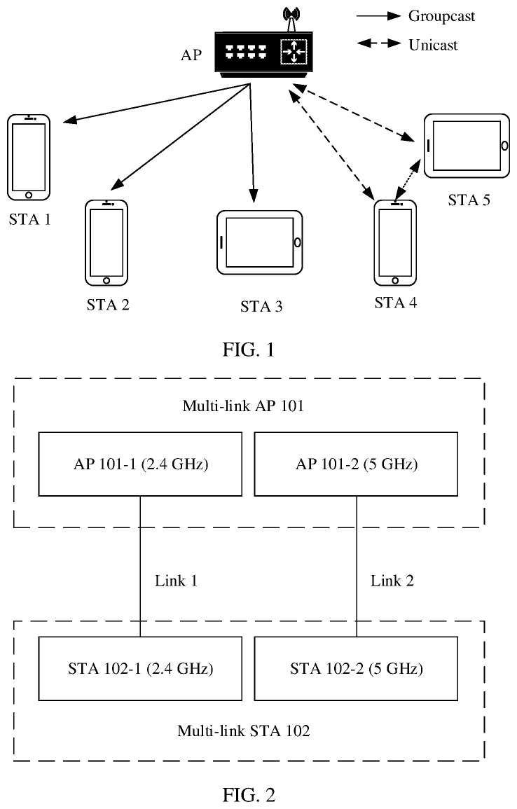

In an example, FIG. 1 is a diagram of an architecture of the WLAN communication system according to this application. In FIG. 1, an example in which the WLAN includes one AP, and the AP is associated with a STA 1, a STA 2, a STA 3, a STA 4, and a STA 5 is used. The AP may schedule a radio resource for a STA associated with the AP and/or a STA not associated with the AP, and transmit data for the STA on the scheduled radio resource. For example, the AP may schedule radio resources for the STA 1, the STA 2, the STA 3, the STA 4, and the STA 5, and transmit data, including uplink data information and/or downlink data information, for the STA 1, the STA 2, the STA 3, the STA 4, and the STA 5 on the scheduled radio resources.

In addition, this embodiment of this application is applicable to communication between an AP and a STA, for example, groupcast communication between the AP and the STA 1, the STA 2, and the STA 3, and unicast communication between the AP and the STA 4 or the STA 5; and this embodiment of this application is also applicable to communication between STAs, for example, communication between the STA 4 and the STA 5. In addition, the AP and the STA in this embodiment of this application may be wireless communication devices that support concurrent transmission on a plurality of links, for example, are referred to as a multi-link device (MLD) or a multi-band device (MBD), and have higher transmission efficiency and a higher throughput. In this specification, an AP supporting communication on the plurality of links may be referred to as an MLD AP, and a STA supporting communication on the plurality of links, namely, a multi-link STA, may be referred to as a non-access point station (non-AP STA). It should be understood that numbers of APs and STAs in FIG. 1 are merely examples, and may be more or less.

FIG. 2 is a diagram of a network architecture of multi-link communication according to an embodiment of this application. It is shown that, in a wireless local area network, a multi-link device communicates with another device on a plurality of links. FIG. 2 is a schematic diagram of communication between a multi-link AP device 101 and a multi-link STA 102. The multi-link AP device 101 includes an affiliated AP 101-1 and an affiliated AP 101-2. The multi-link STA 102 includes an affiliated STA 102-1 and an affiliated STA 102-2. The multi-link AP device 101 and the multi-link STA 102 concurrently communicate on a link 1 and a link 2.

The multi-link device in this embodiment of this application may be a single-antenna device, or may be a multi-antenna device. For example, the multi-link device may be a device with more than two antennas. A number of antennas included in the multi-link device is not limited in this embodiment of this application. In this embodiment of this application, the multi-link device may allow traffic of a same access type to be transmitted on different links, or even allow same data packets to be transmitted on different links. Alternatively, the multi-link device may not allow traffic of a same access type to be transmitted on different links, but may allow traffic of different access types to be transmitted on different links. The multi-link device may operate on a frequency band of sub 1 GHz, 2.4 GHz, 5 GHz, 6 GHz, and high-frequency 60 GHz.

The STA in this embodiment of this application may be a wireless communication chip, a wireless sensor, or a wireless communication terminal. For example, the STA may be a user terminal, a user apparatus, an access apparatus, a subscriber station, a subscriber unit, a mobile station, a user agent, or user equipment that supports wireless fidelity (Wi-Fi) communication. The user terminal may include various devices having a wireless communication function, for example, a handheld device, a vehicle-mounted device, a wearable device, an Internet of things (IoT) device, a computing device, another processing device connected to a wireless modem, user equipment (UE) in various forms, a mobile station (MS), a terminal, a terminal device, a portable communication device, a handheld device, a portable computing device, an entertainment device, a game device or system, a global positioning system device, or any other suitable device configured to perform network communication by using a wireless medium. In addition, the STA may support the 802.11be standard. The STA may also support a plurality of WLAN standards such as 802.11ax, 802.11ac, 802.11n, 802.11g, 802.11b, and 802.11a.

The AP in embodiments of this application may be an apparatus that is deployed in a wireless communication network to provide a wireless communication function for a STA associated with the AP. The AP is mainly deployed at home, inside a building, and in a campus, with a typical coverage radius of tens of meters to hundreds of meters. Certainly, the AP may alternatively be deployed outdoors. The AP is equivalent to a bridge that connects a wired network and a wireless network. The AP is mainly used to connect wireless network clients to each other, and then connect the wireless network to the Ethernet. Specifically, the AP may be a communication device with a Wi-Fi chip, for example, a base station, a router, a gateway, a repeater, a communication server, a switch, or a bridge. The base station may include a macro base station, a micro base station, a relay station, and the like in various forms. In addition, the AP may support the 802.11be standard. The AP may also support WLAN standards such as 802.11ax, 802.11ac, 802.11n, 802.11g, 802.11b, and 802.11a.

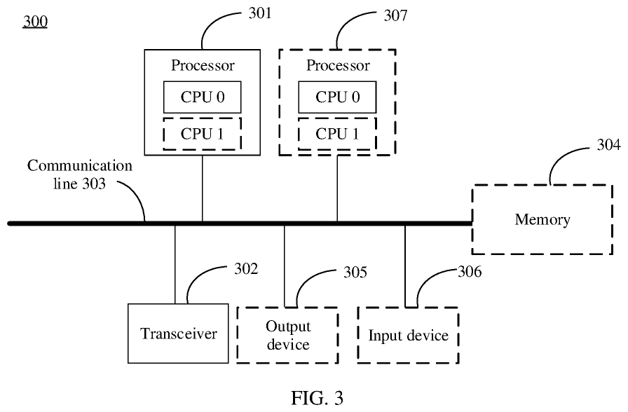

In some embodiments, the AP and the STA in this application may be collectively referred to as a WLAN device. During specific implementation, the WLAN device may use a composition structure shown in FIG. 3, or include components shown in FIG. 3.

FIG. 3 is a schematic diagram of composition of a WLAN device 300 according to an embodiment of this application. The WLAN device 300 may be a STA, a chip in the STA, or a chip system (or referred to as a system on chip); or may be an AP, a chip in the AP, or a chip system (or referred to as a system on chip). In this embodiment of this application, the chip system may include a chip, or may include a chip and another discrete component.

As shown in FIG. 3, the WLAN device 300 includes a processor 301, a transceiver 302, and a communication line 303. Further, the WLAN device 300 may include a memory 304. The processor 301, the memory 304, and the transceiver 302 may be connected by using the communication line 303.

The processor 301 is a central processing unit (CPU), a general-purpose processor, a network processor (NP), a digital signal processor (DSP), a microprocessor, a microcontroller, a programmable logic device (PLD), or any combination thereof. Alternatively, the processor 301 may be another apparatus having a processing function, for example, a circuit, a component, or a software module. This is not limited.

The transceiver 302 is configured to communicate with another device or another communication network. The another communication network may be an Ethernet, a radio access network (RAN), a WLAN, or the like. The transceiver 302 may be a module, a circuit, a transceiver, or any apparatus that can implement communication.

The communication line 303 is configured to transmit information between components included in the WLAN device 300.

The memory 304 is configured to store instructions. The instructions may be a computer program.

The memory 304 may be a read-only memory (ROM) or another type of static storage device that can store static information and/or instructions, or may be a random access memory (RAM) or another type of dynamic storage device that can store information and/or instructions, an electrically erasable programmable read-only memory (EEPROM), a compact disc read-only memory (CD-ROM) or another compact disc storage, an optical disc storage (including a compressed optical disc, a laser disc, an optical disc, a digital versatile disc, a Blu-ray disc, or the like), a magnetic disk storage medium or another magnetic storage device, or the like. This is not limited.

It should be noted that the memory 304 may be independent of the processor 301, or may be integrated with the processor 301. The memory 304 may be configured to store instructions, program code, some data, or the like. The memory 304 may be located inside the WLAN device 300, or may be located outside the WLAN device 300. This is not limited. The processor 301 is configured to execute the instructions stored in the memory 304, to implement methods provided in the following embodiments of this application.

In an example, the processor 301 may include one or more CPUs, for example, a CPU 0 and a CPU 1 in FIG. 3.

In an optional implementation, the WLAN device 300 includes a plurality of processors. For example, in addition to the processor 301 in FIG. 3, the WLAN device 300 may further include a processor 307.

In an optional implementation, the WLAN device 300 further includes an output device 305 and an input device 306. For example, the input device 306 is a device such as a keyboard, a mouse, a microphone, or a joystick, and the output device 305 is a device such as a display or a speaker.

It should be understood that the composition structure shown in FIG. 3 does not constitute a limitation on the WLAN device. In addition to the components shown in FIG. 3, the WLAN device may include more or fewer components than those shown in the figure, or some components may be combined, or the components may be disposed in a different manner.

The foregoing describes the WLAN communication system and the WLAN device provided in this application. For ease of understanding the technical solutions in embodiments of this application, the following briefly describes technologies related to this application.

1. Null Data Packet (NDP) Feedback (NDP Feedback)

The NDP feedback is an efficient 1-bit feedback mechanism defined in the 802.11ax standard. Currently, a feedback type supported by an NDP feedback mechanism defined in the 802.11ax standard is a feedback resource request (RR).

A basic principle of the feedback resource request is as follows: An AP sends an NDP feedback report poll (NFRP) trigger (Trigger) frame to a STA associated with the AP. The NFRP trigger frame includes information such as a starting association identifier (AID), a bandwidth, and a multiplexing flag. The starting AID and the multiplexing flag are included in a user information field (User Info field) of the NFRP trigger frame.

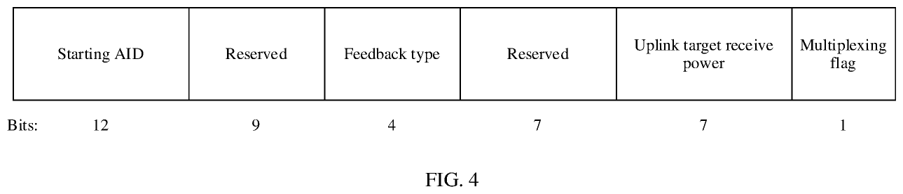

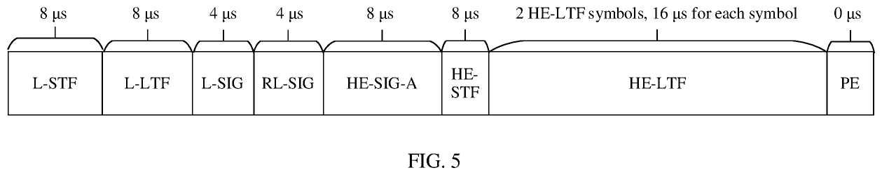

For example, FIG. 4 shows a format of the user information field of the NFRP trigger frame. The user information field includes a 12-bit starting AID (Starting AID) field, a 9-bit reserved (Reserved) field, a 4-bit feedback type (Feedback Type) field, a 7-bit reserved (Reserved) field, a 7-bit uplink target receive power (UL Target Receive Power) field, and a 1-bit multiplexing flag (Multiplexing Flag) field.

The starting AID field indicates an AID of a start STA scheduled by the AP. The feedback type field indicates a feedback type currently supported by the NFRP trigger frame, and when a value of the field is 0, it indicates that the feedback type is a resource request. The uplink target receive power field indicates receive power that is of a feedback signal and that is expected by the AP. The multiplexing flag field is used to determine a number of stations scheduled by the AP.

After receiving the NFRP trigger frame, the STA determines, based on the bandwidth and the multiplexing flag in the NFRP trigger frame, a number of stations N_STA scheduled by the AP. If an AID of the STA is greater than or equal to the starting AID and is less than the starting AID+N_STA, it indicates that the STA is the STA scheduled by the AP. For example, the number of stations N_STA scheduled by the AP satisfies Formula (1):

N_STA=18*2^{BW}*(MultiplexingFlag+1) (1)

In the formula, BW indicates a channel bandwidth. For example, when BW is equal to 0, it indicates that the channel bandwidth is 20 MHz; when BW is equal to 1, it indicates that the channel bandwidth is 40 MHz; when BW is equal to 2, it indicates that the channel bandwidth is 80 MHz; or when BW is equal to 3, it indicates that the channel bandwidth is 80 MHz+80 MHz, or 160 MHz. MultiplexingFlag is a value of the multiplexing flag field in the NFRP trigger frame.

The scheduled STA determines, based on a fact whether the scheduled STA has to-be-sent data, whether to send an NDP feedback report response (NFRR) frame to the AP. For example, when the scheduled STA has no to-be-sent data, the scheduled STA does not send the NDP feedback report response frame; or when the scheduled STA has the to-be-sent data, the scheduled STA sends the NDP feedback report response frame.

Specifically, in the 802.11ax standard, a frame structure of the NDP feedback report response frame is similar to that of a high efficiency (HE) trigger-based (TB) physical protocol data unit (PPDU) (HE TB PPDU). A difference lies in that the NDP feedback report response frame does not include a data field, and duration of a packet extension (PE) field is 0 microseconds (μs).

For example, as shown in FIG. 5, the frame structure of the NDP feedback report response frame includes a legacy-short training field (L-STF), a legacy-long training field (L-LTF), a legacy-signal field (L-SIG), a repeated legacy-signal field (RL-SIG), a high efficiency-signal field A (HE-SIG A), a high efficiency-short training field (HE-STF), a high efficiency-long training field (HE-LTF), and a packet extension (packet extension, PE). Duration of the PE is 0 μs. It may also be understood as that the NDP feedback report response frame does not include the PE.

Before sending the NFRP trigger frame, the AP configures, by using a broadcast frame, two subcarrier sets NDP_TONE_SET_0 and NDP_TONE_SET_1 for the STAs scheduled by the AP. Each STA scheduled by the AP has an associated subcarrier in NDP_TONE_SET_0 and an associated subcarrier in NDP_TONE_SET_1. The associated subcarriers are used by the scheduled STA to send the NDP feedback report response frame.

For example, the STAs scheduled by the AP include a STA 1, a STA 2, and a STA 3. NDP_TONE_SET_0 may include a subcarrier 11 associated with the STA 1, a subcarrier 21 associated with the STA 2, and a subcarrier 31 associated with the STA 3. NDP_TONE_SET_1 may include a subcarrier 12 associated with the STA 1, a subcarrier 22 associated with the STA 2, and a subcarrier 32 associated with the STA 3.

When the scheduled STA has the to-be-sent data, the scheduled STA may send the NDP feedback report response frame to the AP on a subcarrier associated with the scheduled STA in NDP_TONE_SET_0. This indicates that an RR fed back by the STA is between 1 and an RR buffer threshold. In this scenario, it may be considered that a feedback status of the NDP feedback report response frame is a state 0. Alternatively, when the scheduled STA has the to-be-sent data, the scheduled STA may send the NDP feedback report response frame to the AP on a subcarrier associated with the scheduled STA in NDP_TONE_SET_1. This indicates that an RR fed back by the STA is greater than an RR buffer threshold. In this scenario, it may be considered that a feedback status of the NDP feedback report response frame is a state 1.

For example, when the STA 1 scheduled by the AP has the to-be-sent data, if the RR determined by the STA is between 1 and the RR buffer threshold, the STA 1 sends the NDP feedback report response frame to the AP on the subcarrier 11 in NDP_TONE_SET_0; or if the RR determined by the STA is greater than the RR buffer threshold, the STA 1 sends the NDP feedback report response frame to the AP on the subcarrier 12 in NDP_TONE_SET_1.

2. Uplink OFDMA-Based Random Access (UL OFDMA-Based Random Access, UORA)

OFDMA is uplink orthogonal frequency division multiple access (OFDMA).

The UORA is an OFDMA-based uplink random access mechanism defined in the 802.11ax standard. A basic principle is as follows:

An AP allocates, by using a trigger frame, a resource unit (RU) for random access. Specifically, the trigger frame includes one or a plurality of user information fields (UIF), one RU is configured for each UIF, and a plurality of consecutive RUs of a same size may be configured for the plurality of UIFs. In addition, each UIF includes one “AID 12” field. When the “AID 12” field is set to 0, it indicates that an RU currently configured for the UIF is an RU allocated to a STA associated with the AP. When the “AID 12” field is set to 2045, it indicates that an RU currently configured for the UIF is an RU allocated to a STA not associated with the AP.

One RU includes a plurality of subcarriers, and a plurality of subcarriers included in different RUs are different. Further, the plurality of subcarriers included in one RU are orthogonal to each other.

It should be noted that the AP does not specify a STA to which the RU allocated by using the trigger frame is allocated. A STA receiving the trigger frame may use an OFDMA contention window (OCW) and OFDMA random access backoff (OBO) to select the RU allocated by using the trigger frame, to perform uplink sending.

Specifically, a STA supporting the UORA may randomly select a value from [0, OCW] as an initial value of an OBO counter. After receiving a UORA trigger frame, the STA subtracts the initial value of the OBO counter from a total number of RUs configured for the UORA trigger frame. If a value is less than or equal to 0, the STA randomly selects an UR from the RUs configured for the UORA trigger frame, to perform uplink sending. If a value is greater than 0, the STA continues to back off and waits for a next UORA trigger frame.

3. Aggregate-MAC Protocol Data Unit (APMDU)

MAC is media access control (MAC).

The APMDU is a physical layer data frame or a physical layer packet obtained by aggregating a plurality of MDPUs, each of which is encapsulated by a MAC service data unit (MSDU) or an aggregate-MAC service data unit (AMSDU).

For the AMPDU, a transmit end needs to perform channel contention or backoff only once, that is, the transmit end may simultaneously send the plurality of MPDUs, to reduce channel resource consumption caused by separately sending the MDPUs.

4. Block Acknowledgement (BA)

After receiving an AMPDU, a receive end decodes each MPDU in the AMPDU, and performs a feedback for sending each MPDU. In a BA mechanism, a feedback of a plurality of MDPUs included in the AMPDU is completed by using one BA frame, to reduce a number of feedback frames. Specifically, the BA frame may include a block acknowledgement bitmap to feed back a decoding status of each MPDU.

5. Network Allocation Vector (NAV)

The NAV is a virtual carrier sensing method defined for a WLAN. After obtaining a channel through contention, a WLAN device usually sends one or more frames. When a NAV method is used, the WLAN device that obtains the channel may set a NAV in a duration field in a MAC frame header included in each frame sent by the WLAN device, to notify another WLAN device of duration in which the WLAN device that currently obtains the channel uses the channel. Another WLAN device that monitors the frame keeps silent within the duration, that is, stops contending for the channel.

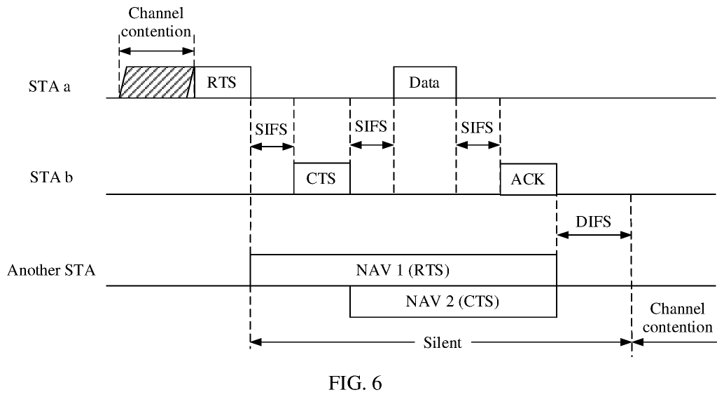

For example, as shown in FIG. 6, a STA a obtains a channel through contention, and the STA a transmits data with a STA b. After obtaining the channel through contention, the STA a sends a request to send (RTS) frame in a broadcast manner. A NAV 1 is set in the RTS frame to indicate a STA 1 to send a data frame to a specified receive end (the STA b) within duration indicated by the NAV 1. After receiving the RTS frame and waiting for a short interframe space (SIFS), the STA b sends a clear to send (CTS) frame in a broadcast manner to acknowledge sending by the STA a. A NAV 2 is set in the CTS frame to indicate duration of using the channel. A start moment of the duration indicated by the NAV 2 is an end moment of the CTS frame, and end moments of the duration indicated by the NAV 2 and the duration indicated by the NAV 1 are the same. Then, the STA a sends a data frame to the STA b, and the STA b replies to the STA a with an acknowledgement (ACK) frame.

It may be understood that the NAV is also included in the data frame sent by the STA a and the ACK frame sent by the STA b, which is not shown in FIG. 6. Another STA that receives the RTS frame or the CTS frame keeps silent within the duration indicated by the NAV 1, and the another STA starts to contend for the channel after a DIFS at which the duration indicated by the NAV 1 ends.

6. Unicast and Groupcast

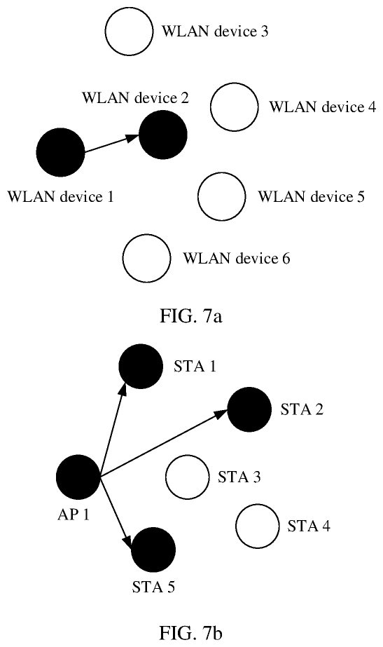

The unicast is a point-to-point transmission mode, that is, one transmit end corresponds to one receive end. For example, as shown in FIG. 7a, it is assumed that there are six WLAN devices including a WLAN device 1 to a WLAN device 6. The transmit end may be the WLAN device 1, and the receive end may be only the WLAN device 2. In this case, it may be considered that unicast transmission is performed between the WLAN device 1 and the WLAN device 2.

The groupcast is a point-to-multipoint transmission mode. Unless otherwise specified, the groupcast in this application is groupcast transmission between an AP and a plurality of STAs, that is, the AP needs to send only one data copy to all STAs in a groupcast group. For example, as shown in FIG. 7b, it is assumed that there are an AP 1 and five STAs including a STA 1 to a STA 5. The AP 1 may serve as the transmit end. When the AP 1 needs to send same data to the STA 1, the STA 2, and the STA 5, the receive end may include the STA 1, the STA 2, and the STA 5. In other words, STAs in the groupcast group may include the STA 1, the STA 2, and the STA 5.

In a WLAN, a radio channel is unstable due to factors such as small-scale fast fading, occlusion and shadow fading, and co-channel interference. To ensure transmission reliability, the AP needs to perform rate adaptation and retransmission based on a quality status of the channel. In unicast transmission, the AP may obtain link quality and data transmission reliability of a channel by using an acknowledgement feedback of a STA. According to an acknowledgement feedback mechanism, transmission reliability may be ensured through retransmission, and a modulation and coding scheme (MCS) may be adjusted to implement link rate adaptation, and ensure high transmission efficiency. For groupcast transmission, conventional IEEE 802.11 does not define an effective acknowledgement feedback mechanism. This brings two typical problems: (1) Because groupcast STAs do not have any acknowledgement feedback, reliability in a groupcast scenario cannot be ensured through retransmission; and (2) because groupcast data flows are sent at a fixed minimum rate, link quality information cannot be obtained to implement rate adaptation; and potential advantages of groupcast transmission efficiency cannot be brought into play.

It should be noted that the groupcast STAs in this application are STAs in the groupcast group, or STAs that serve as the receive end in groupcast transmission. The three descriptions may be replaced to each other. This is not specifically limited in this application.

For a groupcast service reliability problem, in the conventional 802.11 standard, an effective choice in a light-load scenario is that the AP converts a groupcast packet into a unicast packet and sends the unicast packet. In this way, reliability of each terminal is ensured through an ACK feedback and retransmission in a unicast transmission mode. In addition, rate adaptation can be implemented according to the acknowledgement feedback mechanism in a unicast scenario, to select a proper transmission rate for users based on different channel quality. However, converting the groupcast packet into the unicast packet causes repeated transmission of packets. For a same data flow, compared with the groupcast, for the unicast, a bandwidth resource or a delay that is required increases sharply as a number of STAs in the groupcast group increases. As a result, it is difficult to apply this solution to a high user density scenario.

Currently, many groupcast services in a high user density scenario, such as VR teaching, video conferencing, and an electronic schoolbag, are available on a WLAN network. These services require the AP to support a large number of STAs and pose ultimate requirements on reliability, throughput, the delay, and the like. Therefore, to ensure efficient and reliable transmission of the groupcast services in the high-density scenario on the WLAN network, optimization of a groupcast service sending feedback method is used as one of the main topics for discussion in 802.11bc.

Currently, a groupcast with retries (GCR) feedback mechanism is proposed in the 802.11aa standard. According to the mechanism, an existing BA mechanism in the 802.11 standard is extended to a group addressed transmission service (GATS) scenario, that is, the BA mechanism is extended to the groupcast scenario.

Specifically, according to the feedback mechanism, the AP sends a groupcast AMPDU to STAs in the groupcast group, and then polls some or all of STAs in the groupcast group by using a block ACK request (BAR) frame. After an SIFS elapses, a STA that receives the BAR frame replies to the AP with a BA frame, to notify the AP a decoding status of the groupcast AMPDU.

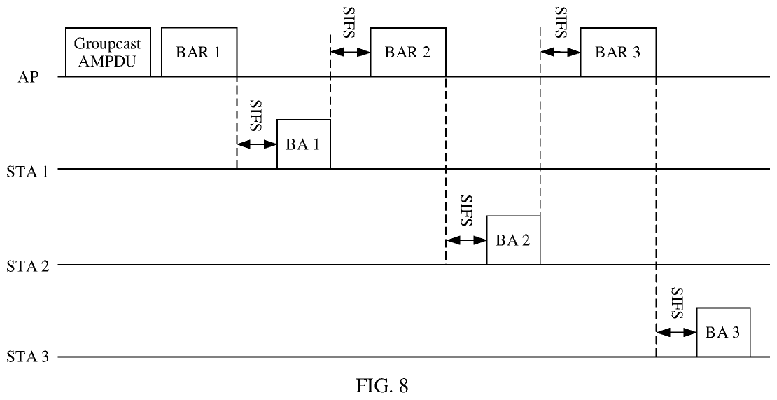

For example, as shown in FIG. 8, the STAs in the groupcast group include a STA 1, a STA 2, and a STA 3. The AP first sends the groupcast AMPDU, and then sends a BAR 1 to the STA 1. After receiving the BAR 1, the STA 1 replies to the AP with a BA 1. After receiving the BA 1, the AP continues to send a BAR 2 to the STA 2. After receiving the BAR 1, the STA 2 replies to the AP with a BA 2. Similarly, after receiving the BA 2, the AP continues to send a BAR 3 to the STA 3. After receiving the BAR 3, the STA 2 replies to the AP with a BA 3.

It can be learned from FIG. 8 that, according to the feedback mechanism, the AP requests groupcast STAs to feed back BA frames one by one in a polling manner. As a number of groupcast STAs increases, numbers of BAR frames and BA frames exchanged between the AP and the groupcast STAs in the mechanism also increase. When the feedback mechanism is applied to a high-density scenario, huge transmission overheads of a GCR control frame are caused.

To reduce the transmission overheads of the GCR control frame, the 802.11ax standard optimizes a GCR feedback mechanism, and defines a GCR MU-BAR mechanism. MU is a multi-user (multi-user, MU). According to the GCR MU-BAR mechanism, an AP sends the groupcast AMPDU to the STAs in the groupcast group. Then, the AP schedules a plurality of STAs in the groupcast group by using an MU-BAR frame, to reply with BA frames on RUs allocated to the plurality of STAs.

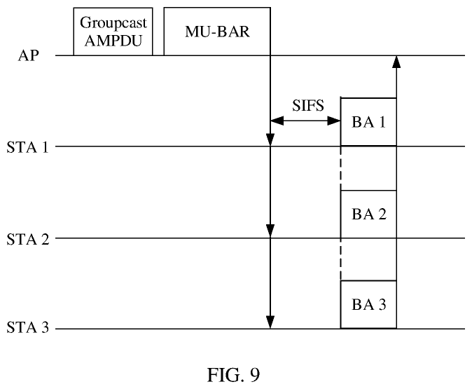

For example, as shown in FIG. 9, the STAs in the groupcast group include a STA 1, a STA 2, and a STA 3. The AP first sends the groupcast AMPDU, and then sends a MU-BAR frame. RUs are respectively allocated to the STA 1, the STA 2, and the STA 3 in the MU-BAR frame. After receiving the MU-BAR frame, the STA 1, the STA 2, and the STA 3 respectively reply to the AP with a BA 1, a BA 2, and a BA 3 on the RUs allocated by the AP to the STA 1, the STA 2, and the STA 3.

It can be learned from FIG. 9 that, according to the feedback mechanism, the AP may request, by using one MU-BAR frame, a plurality of groupcast STAs to feed back the BA frames. Compared with the solution shown in FIG. 8, transmission overheads of a GCR control frame can be reduced in this solution. However, one MU-BAR frame can request to feed back a limited number of groupcast STAs. In a high user density scenario, to ensure that the AP collects BA frames of all groupcast STAs, the AP still needs to send a plurality of MU-BARs, that is, a plurality of rounds of interactions of the GCR control frame need to be performed. For example, when a channel bandwidth is 40 MHz, 18 available RUs can be allocated to STAs to feed back the BA frames. In view of a typical high user density scenario of VR teaching, it is assumed that there are 60 groupcast STAs. To ensure that the AP receives BA frames of the 60 groupcast STAs, a total of four rounds of interaction between the MU-BAR frames and the BA frames are required, and large transmission overheads still exist.

In view of this, this application provides a groupcast feedback method, to feed back a groupcast data frame at low transmission overheads, so that an access point obtains a channel quality status based on a feedback from a station.

With reference to the accompanying drawings, the following describes the technical solutions provided in embodiments of this application.

It should be noted that a length of each field in this application is merely an example for description. In this application, the length of each field is not be limited to a length provided in this application, and each field may be longer or shorter than a field provided in this application.

It should be noted that, in the following embodiments of this application, a name of a message between apparatuses, a name of each parameter, a name of each piece of information, and the like are merely examples, and may alternatively be other names in another embodiment. This is not specifically limited in the method provided in this application.

It may be understood that, in embodiments of this application, the access point and/or a STA may perform some or all of the steps in embodiments of this application. These steps or operations are merely examples. In embodiments of this application, other operations or variants of the operations may be further performed. In addition, the steps may be performed in a sequence different from that shown in embodiments of this application, and possibly, not all the operations in embodiments of this application need to be performed.

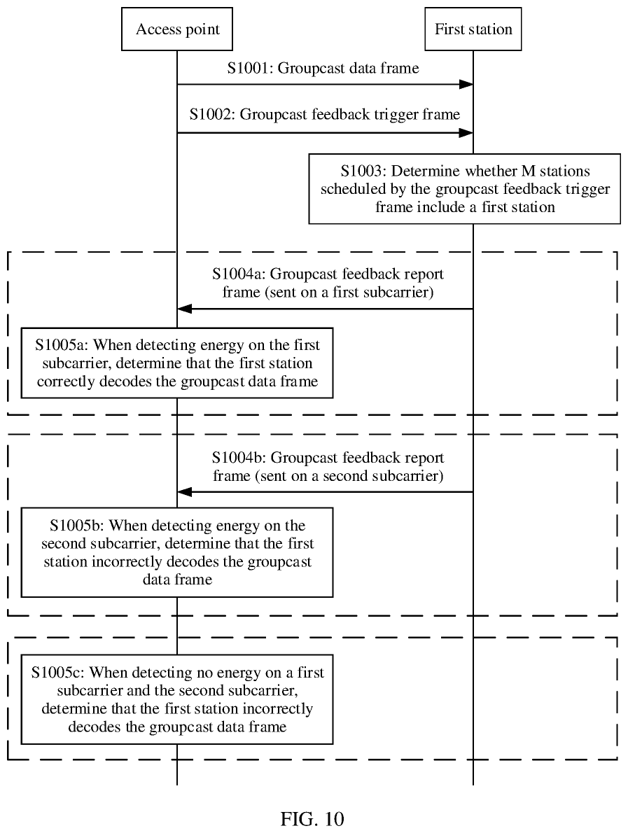

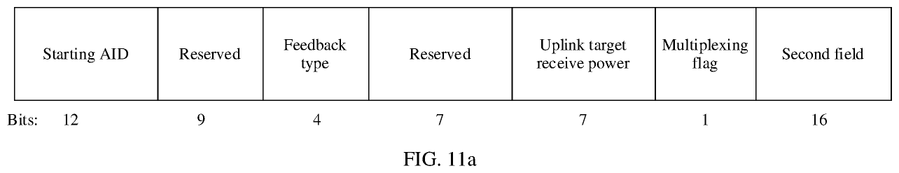

FIG. 10 is a schematic flowchart of a groupcast feedback method according to an embodiment of this application. The following uses an example in which the method provided in this embodiment of this application is applied to the application scenario shown in FIG. 1. Certainly, embodiments of this application may also be applied to another possible communication scenario or communication system. The method provided in embodiments of this application can be used to provide a feedback in any scenario in which a groupcast data frame needs to be fed back.

Specifically, as shown in FIG. 10, a service transmission method provided in this application includes the following steps.

S1001: An access point sends a groupcast data frame. Correspondingly, a first station receives the groupcast data frame from the access point.

The first station is any one of a plurality of stations in the groupcast group.

It may be understood that the groupcast data frame sent by the access point can be received by the plurality of stations in the groupcast group. In this embodiment of this application, an example in which the stations in the groupcast group include the first station, and the first station receives the groupcast data frame is used for description. In the following embodiments, the first station is also used as a subject to describe an operation implemented by the stations in the groupcast group.

It should be understood that the plurality of stations in the groupcast group have a same or similar processing action, and can all perform a function or an action implemented by the first station provided in this application.

In some embodiments, the groupcast data frame includes a plurality of data frames. For example, the groupcast data frame is an AMPDU, and the data frames forming the groupcast data frame are a plurality of MPDUs.

In an example, when the groupcast data frame includes the plurality of data frames, the data frame may also be referred to as a sub-data frame of the groupcast data frame. For example, when the groupcast data frame is the AMPDU, the MPDU may also be referred to as a sub-data frame of the AMPDU.

In some other embodiments, the groupcast data frame includes only one data frame. For example, the data frame is the MPDU, and the groupcast data frame includes only one MPDU, or the groupcast data frame is the MPDU.

S1002: The access point sends a groupcast feedback trigger frame. Correspondingly, the first station receives the groupcast feedback trigger frame from the access point.

The groupcast feedback trigger frame is used to schedule the plurality of stations in the groupcast group to indicate whether the groupcast data frame is correctly decoded.

For ease of description, in this application, a number of all stations in the groupcast group is denoted as N, that is, the groupcast group includes N stations in total. A number of the plurality of stations in the groupcast group that are scheduled by the groupcast feedback trigger frame is recorded as M, that is, the groupcast feedback trigger frame schedules M stations in the groupcast group to indicate whether the groupcast data frame is correctly decoded. The M stations include the first station. M and N are positive integers greater than 1, and M is less than or equal to N.

In some embodiments, a value of M is positively correlated with a channel bandwidth. In other words, a number of stations in the groupcast group that are scheduled by one groupcast feedback trigger frame and that indicate whether the groupcast data frame is correctly decoded is positively related to the channel bandwidth. That is, a larger channel bandwidth indicates a larger number of stations scheduled by the groupcast feedback trigger frame.

In an example, the value of M and the channel bandwidth satisfy Formula (2):

M=C*2^{BW}*(MultiplexingFlag+1) (2)

In the formula, C is a constant value of 18, indicating a minimum number of stations that can be scheduled at a time when the bandwidth is 20 MHz. BW indicates the channel bandwidth. For example, when BW is equal to 0, it indicates that the channel bandwidth is 20 MHz; when BW is equal to 1, it indicates that the channel bandwidth is 40 MHz; when BW is equal to 2, it indicates that the channel bandwidth is 80 MHz; or when BW is equal to 3, it indicates that the channel bandwidth is 80+80 MHz, or 160 MHz. A value of MultiplexingFlag is 0 or 1.

For example, the channel bandwidth is 40 MHz, and a maximum value of M is 72. To be specific, in this application, the access point indicates, based on a fact that one groupcast feedback trigger frame can schedule a maximum of 72 stations in the groupcast group, whether the groupcast data frame is correctly decoded. However, in a GCR MU-BAR feedback solution shown in FIG. 9, when the channel bandwidth is 40 MHz, there are 18 RUs that can be used for a feedback, that is, one MU-BAR frame can schedule a maximum of 18 stations in the groupcast group to indicate whether the groupcast data frame is correctly decoded. It is assumed that one groupcast group includes 60 stations in total. In a solution of this application, the access point needs to send only one groupcast feedback trigger frame to schedule the 60 stations to provide a feedback. If a solution shown in FIG. 9 is used, to schedule the 60 stations to provide a feedback, the access point needs to send four MU-BAR frames. It can be learned that overheads of a control frame can be reduced by using the solution in this application.

In some embodiments, the groupcast feedback trigger frame includes a first field. When a value of the first field is a first value, it indicates that a type of the groupcast feedback trigger frame is a groupcast with retries acknowledgement request. The station in the groupcast group can determine the type of the groupcast feedback trigger frame by using the first field, to further provide a feedback based on the feedback trigger frame.

In an example, the groupcast feedback trigger frame is an NFRP trigger frame, and the first field is a feedback type field in a user information field of the NFRP trigger frame. For a structure of the user information field, refer to FIG. 4. Details are not described herein again. Further, the first value may be any one of 1 to 15. For example, the first value is equal to 1. A value of the feedback type field and a corresponding feedback type are shown in Table 1.

TABLE 1

| Feedback | | |
|---|---|---|
| type field | Feedback type | Description |
| 0 | Resource request | Used to indicate a scheduled |
| | | STA to indicate whether there |
| | | is to-be-sent data. |
| 1 | Groupcast with retries | Used to indicate a scheduled |
| | acknowledgement request | STA to indicate whether a |
| | (GCR acknowledgement | groupcast data frame is |
| | request) | correctly decoded. |
| 2-15 | Reserved (reserved) | |

In other words, in this application, the feedback type field of the NFRP trigger frame may be reused, and a reserved value of a feedback type field in the 802.11ax standard may be used to indicate the groupcast with retries acknowledgement request, to indicate the scheduled STA to indicate whether the groupcast data frame is correctly decoded.

In some embodiments, the groupcast feedback trigger frame includes a second field, and the second field indicates the groupcast data frame. The second field can explicitly indicate the groupcast data frame, so that the station in the groupcast group can determine that the groupcast data frame indicated by the groupcast feedback trigger frame needs to be fed back, to feed back the groupcast data frame. In this way, the access point and the station have a consistent understanding of a feedback object, and feedback accuracy is improved.

In an example, the groupcast feedback trigger frame is the NFRP trigger frame, and the second field is a field in the user information field of the NFRP trigger frame. In other words, in this application, the second field is extended in the user information field of the NFRP trigger frame defined in the 802.11ax standard, to indicate a groupcast data frame that needs to be fed back.

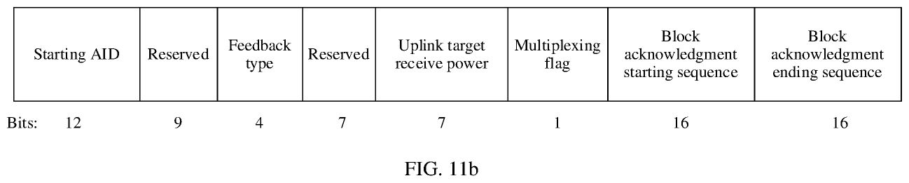

For example, a structure of the user information field of the NFRP trigger frame may be shown in FIG. 11a. The second field may be set as an index of the groupcast data frame. For example, when the groupcast data frame is the MPDU, the second field may be set as a sequence number index of the MPDU. When the groupcast data frame is the AMPDU, the second field may be set as an index of the AMPDU, that is, the AMPDU may be numbered. An index of one AMPDU is used to uniquely identify the AMPDU. The second field can be set as the index of the AMPDU to uniquely determine a fed-back AMPDU.

In an example, the second field may include a first subfield and a second subfield. The first subfield is used to carry a sequence number index of a start data frame in the groupcast data frame. The second subfield is used to carry a sequence number index of an end data frame in the groupcast data frame.

For example, the first subfield may be referred to as a block acknowledgement starting sequence (Block ACK Starting Sequence) field, and the second subfield may be referred to as a block acknowledgement ending sequence (Block ACK Ending Sequence) field. The structure of the user information field of the NFRP trigger frame may be shown in FIG. 11b.

For example, for the structure shown in FIG. 11b, when the groupcast data frame is the MPDU, both the block acknowledgement starting sequence field and the block acknowledgement ending sequence field may be set as the sequence number index of the MPDU. When the groupcast data frame is the AMPDU, the block acknowledgement starting sequence field may be set as a sequence number index of a start MPDU in the AMPDU, and the block acknowledgement ending sequence field may be set as a sequence number index of an end MPDU in the AMPDU.

In another example, the second field may include a first subfield and a second subfield. The first subfield is used to carry a sequence number index of a start data frame in the groupcast data frame. The second subfield is used to carry a number of data frames included in the groupcast data frame.

For example, when the groupcast data frame is the MPDU, the first subfield may be set as the sequence number index of the MPDU, and the second subfield may be set to 1, indicating that the groupcast data frame includes one data frame. When the groupcast data frame is the AMPDU, the first subfield may be set as the sequence number index of the start MPDU in the AMPDU, and the second subfield may be set as a number of MPDUs included in the AMPDU.

In still another example, the second field may include a first subfield and a second subfield. The first subfield is used to carry a number of data frames included in the groupcast data frame. The second subfield is used to carry a sequence number index of an end data frame in the groupcast data frame.

For example, when the groupcast data frame is the MPDU, the first subfield may be set to 1, indicating that the groupcast data frame includes one data frame, and the second subfield may be set as the sequence number index of the MPDU. When the groupcast data frame is the AMPDU, the first subfield may be set as a number of MPDUs included in the AMPDU, and the second subfield may be set as a sequence number index of an end MPDU in the AMPDU.

It should be noted that the “sequence number index” in this application may also be referred to as a “serial number”, and the “sequence number index” and the “serial number index” may be replaced with each other. This is not specifically limited in this application.

S1003: The first station determines whether the M stations scheduled by the groupcast feedback trigger frame include the first station.

In some embodiments, the groupcast feedback trigger frame may include a starting AID. After receiving the groupcast feedback trigger frame, the first station determines whether an AID of the first station is greater than or equal to the starting AID and is less than a sum of the starting AID and M. If yes, the first station is a station scheduled by the groupcast feedback trigger frame; or if no, the first station is not a station scheduled by the groupcast feedback trigger frame. This application is described by using an example in which the first station is the station scheduled by the groupcast feedback trigger frame, that is, the M stations scheduled by the groupcast feedback trigger frame include the first station.

In some embodiments, after the first station determines that the M stations scheduled by the groupcast feedback trigger frame include the first station, the first station performs the following step S1004a if the first station correctly decodes the groupcast data frame, or the first station performs the following step S1004b or S1004c if the first station incorrectly decodes the groupcast data frame.

S1004a: The first station sends a groupcast feedback report frame to the access point on a first subcarrier.

The first subcarrier is a subcarrier associated with the first station in a first subcarrier set, and the first subcarrier set is used to carry the groupcast feedback report frame when decoding is correct.

In some embodiments, the first subcarrier set may be configured by the access point before step S1002. The first subcarrier set includes N subcarriers that are respectively associated with N stations in the groupcast group, that is, one station in the groupcast group is associated with one subcarrier in the first subcarrier set, and subcarriers associated with different stations are different. In other words, when a station in the groupcast group correctly decodes the groupcast data frame, the station sends the groupcast feedback report frame to the access point on a subcarrier associated with the station in the first subcarrier set.

S1004b: The first station sends a groupcast feedback report frame to the access point on the second subcarrier.

The second subcarrier is a subcarrier associated with the first station in a second subcarrier set, and the second subcarrier set is used to carry the groupcast feedback report frame when decoding is not correct.

In some embodiments, the second subcarrier set may be configured by the access point before step S1002. The second subcarrier set includes N subcarriers that are respectively associated with N stations in the groupcast group, that is, one station in the groupcast group is associated with one subcarrier in the second subcarrier set, and subcarriers associated with different stations are different. In other words, when a station in the groupcast group incorrectly decodes the groupcast data frame, the station sends the groupcast feedback report frame to the access point on a subcarrier associated with the station in the second subcarrier set.

In some embodiments, the first subcarrier set and the second subcarrier set are configured by the access point by using one broadcast frame or two broadcast frames. This is not specifically limited in this application.

S1004c: The first station does not send the groupcast feedback report frame to the access point on a first subcarrier and the second subcarrier.

For the first subcarrier and the second subcarrier, refer to the foregoing descriptions. Details are not described herein again. In other words, when the first station incorrectly decodes the groupcast data frame, the first station may not reply to the access point with the groupcast feedback report frame.

In some embodiments, the groupcast feedback report frame in this application is a null data frame, that is, does not include a data field. The groupcast feedback report frame may also be referred to as a null data packet feedback report frame. For example, a structure of the multicast feedback report frame may be shown in FIG. 5.

It may be understood that the groupcast feedback report frame may be considered as a response frame of the groupcast feedback trigger frame. In other words, the groupcast feedback report frame is a frame triggered by the groupcast feedback trigger frame.

After sending the groupcast feedback trigger frame, the access point may perform energy detection on subcarriers included in the first subcarrier set and the second subcarrier set.

When the first station performs step S1004a, the access point may perform the following step S1005a:

S1005a: When detecting energy on the first subcarrier, the access point determines that the first station correctly decodes the groupcast data frame.

It may be understood that the first subcarrier set is configured by the access point. A station associated with a subcarrier in the first subcarrier set can be determined on the side of the access point. Therefore, when the access point detects the energy on the first subcarrier, because the access point can determine that the first subcarrier is associated with the first station, the access point can determine that the first station correctly decodes the groupcast data frame.

When the first station performs step S1004b, the access point performs the following step S1005b:

S1005b: When detecting energy on the second subcarrier, the access point determines that the first station incorrectly decodes the groupcast data frame.

It may be understood that the second subcarrier set is configured by the access point. A station associated with a subcarrier in the second subcarrier set can be determined on the side of the access point. Therefore, when the access point detects the energy on the second subcarrier, because the access point can determine that the second subcarrier is associated with the first station, the access point can determine that the first station correctly decodes the groupcast data frame.

When the first station performs step S1004c, the access point performs the following step S1005c:
S1005c: When detecting no energy on the first subcarrier and the second subcarrier, the access point determines that the first station incorrectly decodes the groupcast data frame.

In the foregoing solution, the access point can determine, in the M stations scheduled by the groupcast feedback trigger frame, a station that correctly decodes the groupcast data frame and a station that incorrectly decodes the groupcast data frame. When M is less than N, the foregoing solution may be repeatedly performed from step S1002, to schedule another station in the N stations in the groupcast group other than the currently scheduled M stations, to provide a feedback. When M is equal to N, the access point can determine, in the N stations in the groupcast group, the station that correctly decodes the groupcast data frame and the station that incorrectly decodes the groupcast data frame.

Based on the foregoing solution, when the groupcast data frame is the MPDU, the access point schedules the station in the groupcast group to reply with the groupcast feedback report frame, and learns, based on a fact whether energy is detected on a subcarrier associated with the station, whether the station in the groupcast group correctly decodes the MPDU. Then, the access point can retransmit the MPDU to a station that incorrectly performs decoding, to improve transmission reliability, or can adjust a link rate, to improve transmission efficiency.

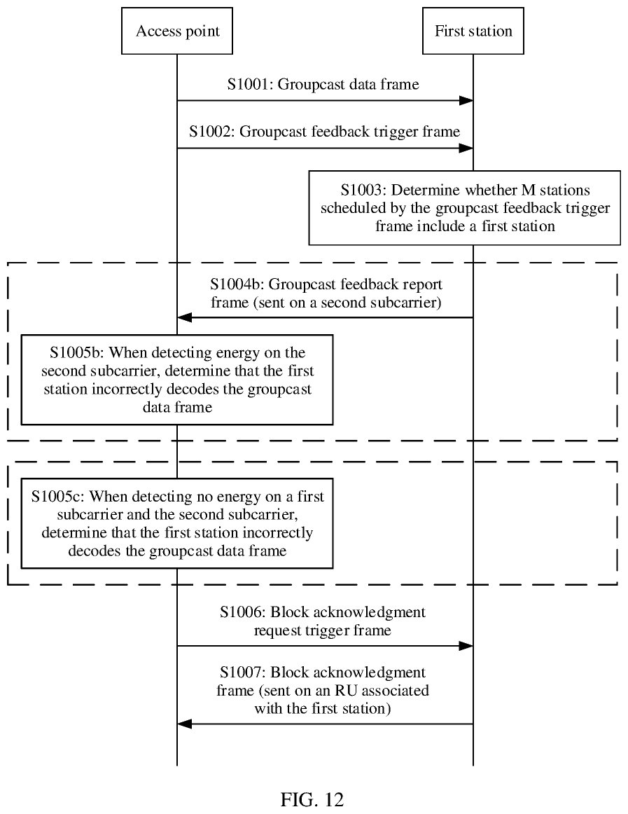

In some embodiments, when the groupcast data frame is the AMPDU, the access point may learn, by using the foregoing solution, a station that incorrectly decodes the AMPDU in the N stations in the groupcast group. Further, to learn an incorrectly decoded MPDU in the AMPDU, as shown in FIG. 12, the method provided in this application further includes the following steps S1006 and S1007.

S1006: The access point sends a block acknowledgement request (block ACK request, BAR) trigger frame. Correspondingly, the first station receives the block acknowledgement request trigger frame from the access point.

The block acknowledgement request trigger frame is used to schedule at least one second station to feed back, on an RU associated with the at least one second station, a sequence number index of the incorrectly decoded MPDU in the AMPDU. The second station is the station that incorrectly decodes the AMPDU in the N stations in the groupcast group.

For ease of description, in this application, a number of the station that incorrectly decodes the AMPDU in the groupcast group is denoted as P, that is, the groupcast group includes P stations in total that incorrectly decode the AMPDU. A number of the at least one second station scheduled by the block acknowledgement request trigger frame is denoted as K, that is, the block acknowledgement request trigger frame schedules K stations in the groupcast group that incorrectly decode the AMPDU, to feed back the sequence number index of the incorrectly decoded MPDU. P and K are positive integers, and K is less than or equal to P.

It should be noted that, in this application, an example in which the first station is one of the at least one second station scheduled by the block acknowledgement request trigger frame is used for description. In other words, in this scenario, the first station is also used as the second station. In addition, for the first station, the block acknowledgement request trigger frame is used to schedule the first station to feed back, on an RU associated with the first station, the sequence number index of the incorrectly decoded MPDU in the AMPDU.

In some embodiments, the block acknowledgement request trigger frame includes an AID of each second station in K second stations, and an RU associated with each second station or an RU allocated to each second station.

In an example, the acknowledgement request trigger frame may be an MU-BAR trigger frame in the 802.11ax standard, or a trigger frame obtained by extending or deleting the MU-BAR trigger frame in the 802.11ax standard.

It may be understood that the block acknowledgement request trigger frame sent by the access point can be received by the K second stations. In this embodiment of this application, a first station in the K second stations is used as an example for description. It should be understood that a plurality of second stations in the K second stations have same or similar processing actions, and can all perform the function or the action implemented by the first station provided in the following embodiment of this application.

S1007: The first station sends, on the RU associated with the first station, a block acknowledgement (bBA) frame to the access point. Correspondingly, the access point receives, on the RU associated with the first station, the block acknowledgement frame from the first station.

The RU associated with the first station is an RU that is allocated to the first station and that is in the block acknowledgement request trigger frame.

The block acknowledgement frame is used to indicate an MPDU that is in the AMPDU and that is incorrectly decoded by the first station. In an example, the block acknowledgement frame may include a block acknowledgement bitmap (block ACK bitmap), that is, the bitmap is used to indicate an incorrectly decoded MPDU. Specifically, each bit in the block acknowledgement bitmap corresponds to one MPDU in the AMPDU. When a bit is 1, it indicates that an MPDU corresponding to the bit is incorrectly decoded, or when the bit is 0, it indicates that the MPDU corresponding to the bit is correctly decoded. Alternatively, when a bit is 0, it indicates that an MPDU corresponding to the bit is incorrectly decoded, or when the bit is 1, it indicates that the MPDU corresponding to the bit is correctly decoded.

For example, the AMPDU includes five MPDUs, sequence number indexes are respectively 10 to 14, and the first station incorrectly decodes the MPDUs whose sequence number indexes are 10, 13, and 14. If a bit of 1 indicates that a corresponding MPDU is incorrectly decoded, then the block acknowledgement bitmap may be 10011. From left to right, the first 1 indicates that the MPDU whose sequence number index is 10 is incorrectly decoded, the second and third 0s respectively indicate that the MPDUs whose sequence number indexes are 11 and 12 are correctly decoded, and the last two 1s respectively indicate that the MPDUs whose sequence number indexes are 13 and 14 are incorrectly decoded.

By using the foregoing steps S1006 and S1007, the access point can determine an MDPU that is incorrectly decoded by each station and that is in the K stations that incorrectly decode the AMPDU. When K is less than P, the foregoing steps S1006 and S1007 may be repeatedly performed, to schedule another station other than the currently scheduled K stations in the P stations that incorrectly decode the AMPDU, to feed back the sequence number index of the incorrectly decoded MPDU. When P is equal to K, the access point can determine the MDPU that is incorrectly decoded by each station and that is in all stations that incorrectly decode the AMPDU.

Based on the foregoing solution, when the groupcast data frame is the AMPDU, this application provides a two-level feedback mechanism. In the first-level feedback, the access point can first schedule, by using the groupcast feedback trigger frame, the station in the groupcast group to reply with the groupcast feedback report frame. In this way, the access point can learn the station that incorrectly decodes the AMPDU in the groupcast group. In the second-level feedback, the access point schedules, by using the block acknowledgement request trigger frame, the station that incorrectly decodes the AMPDU, to feed back the sequence number index of the incorrectly decoded MPDU. Therefore, the access point can retransmit the incorrectly decoded MPDU to improve transmission reliability, or can adjust the link rate to improve transmission efficiency.

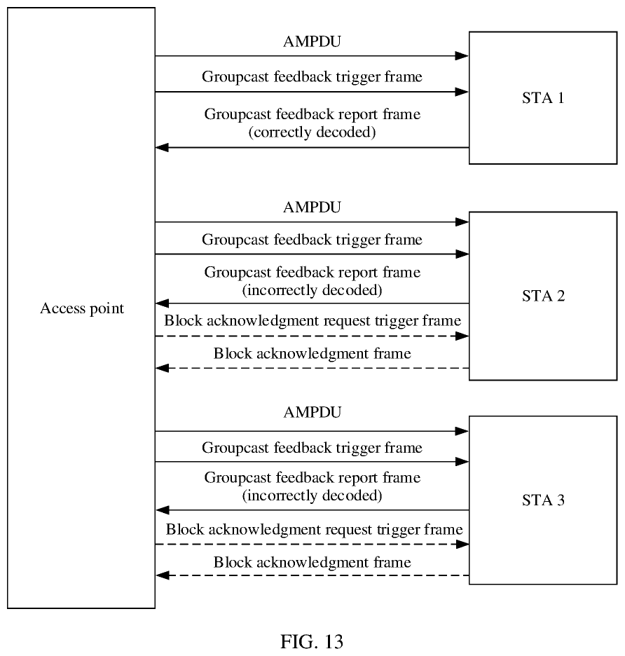

Refer to FIG. 13. For example, the groupcast group includes three STAs: a STA 1, a STA 2, and a STA 3. In the foregoing two-level feedback mechanism, the AP first sends the groupcast data frame AMPDU, and then sends the groupcast feedback trigger frame. It is assumed that the STA 1 correctly decodes the AMPDU, and the STA 2 and the STA 3 incorrectly decode the AMPDU. After receiving the groupcast feedback trigger frame, the STA 2 and the STA 3 separately send the groupcast feedback report frame to the AP on subcarriers associated with the STA 2 and the STA 3 in the second subcarrier set. After receiving the groupcast feedback trigger frame, the STA 1 sends the groupcast feedback report frame to the AP on a subcarrier associated with the STA 1 in the first subcarrier set.

Correspondingly, the access point can determine, based on a subcarrier on which energy is detected, that the STA 2 and the STA 3 incorrectly decode the AMPDU. Therefore, the access point sends the block acknowledgement trigger frame, and schedules the STA 2 and the STA 3 to feed back, on RUs associated with the STA 2 and the STA 3, the index of the incorrectly decoded MPDU in the AMPDU. After receiving the block acknowledgement trigger frame, the STA 2 and the STA 3 respectively send block acknowledgement frames on the RUs associated with the STA 2 and the STA 3, to indicate the incorrectly decoded MPDU.

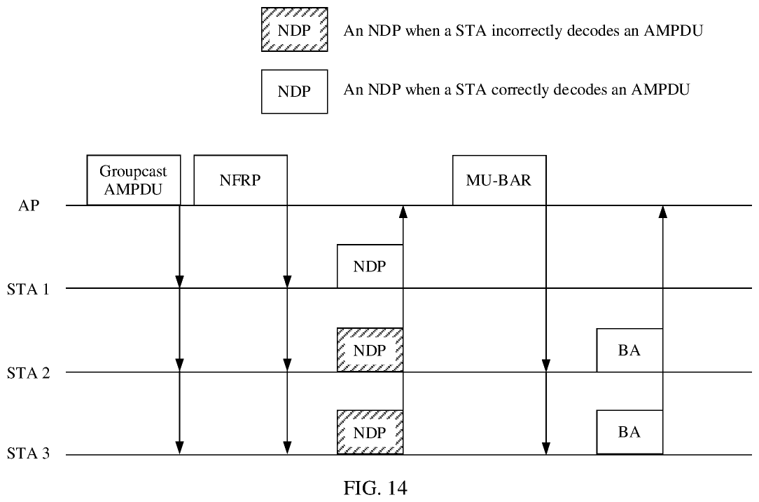

FIG. 14 is a schematic time sequence diagram of the communication procedure shown in FIG. 13. An example in which the groupcast feedback trigger frame is an NFRP frame, the groupcast feedback report frame is an NDP, and the block acknowledgement request trigger frame is an MU-BAR is used for description.

Based on the solution of this application, when the groupcast data frame is the AMPDU, the access point filters out, by using the first-level feedback, a STA that correctly performs decoding. Therefore, in the second-level feedback, an RU can be prevented from being allocated to the STA that correctly performs decoding. This can effectively reduce overheads of interaction between the BAR trigger frame and the BA frame in the second-level feedback.

A channel bandwidth of 40 MHz is used as an example. It is assumed that the groupcast group includes 60 STAs in total, and there are 18 RUs that can be used to feed back the incorrectly decoded MPDU. Based on a GCR MU-BAR feedback mechanism in the 802.11ax standard, the AP needs to send four MU-BAR trigger frames. Correspondingly, the STAs in the groupcast group need to reply with BA frames regardless of whether the STAs correctly decode the AMPDU. Based on the solution of this application, within a specific packet error ratio (PER) range, the AP only needs to send two block acknowledgement trigger frames, and a STA that correctly decodes the AMPDU does not need to reply with the BA frame.

The foregoing describes a groupcast feedback procedure provided in this application. In addition, in this application, a scenario in which there is a non-groupcast station in a coverage area of the access point is considered. In this scenario, data transmission initiated by the non-groupcast station on a channel may cause interference to frames involved in the foregoing procedure. In view of this, channel protection is performed in this application by using an NAV mechanism, to improve reliability of the foregoing feedback procedure.

In some embodiments, the groupcast feedback trigger frame sent by the access point may include a third field, and the third field indicates the first NAV. For example, the third field may be a duration field in a header of the groupcast feedback trigger frame.

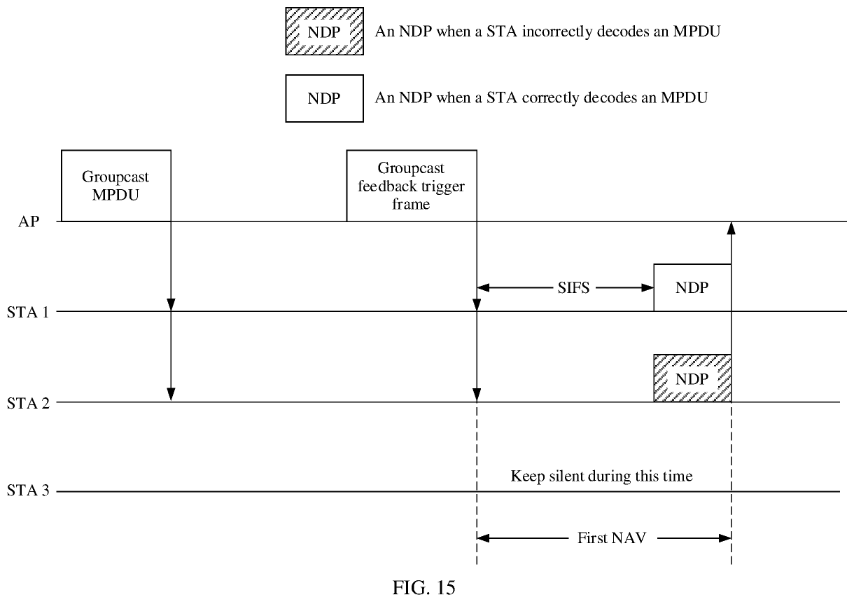

In an example, when the groupcast data frame is the MPDU, duration of the first NAV is a sum of duration of the groupcast feedback report frame and an SIFS, and the groupcast feedback report frame is the response frame of the groupcast feedback trigger frame. For example, as shown in FIG. 15, that the groupcast data frame is the MPDU, STAs in the groupcast group include the STA 1 and the STA 2, and there is a non-groupcast station STA 3 in the coverage area of the AP are used as an example. After sending the MPDU, the AP sends the groupcast feedback trigger frame, and the groupcast feedback trigger frame indicates the first NAV. The STA 1 and the STA 2 are scheduled by the AP to send groupcast feedback report frames (represented by NDPs in FIG. 15) in the first NAV, and the STA 3 keeps silent in the first NAV.

In another example, when the groupcast data frame is the AMPDU, duration of the first NAV is a sum of a plurality of items: duration of the groupcast feedback report frame, duration of the block acknowledgement request trigger frame, duration of the block acknowledgement frame, and an SIFS.

For example, in the foregoing procedure, if one block acknowledgement request trigger frame can schedule all stations in the groupcast group that incorrectly decode the AMPDU, to reply with the block acknowledgement frame, the duration of the first NAV is:

duration of one groupcast feedback report frame+duration of one block acknowledgement request trigger frame+duration of one block acknowledgement frame+3 SIFSs.

If a plurality of block acknowledgement request frames are required to schedule all stations in the groupcast group that incorrectly decode the AMPDU, to reply with the block acknowledgement frame, the duration of the first NAV is:

duration of one groupcast feedback report frame+duration of L block acknowledgement request trigger frames+duration of L block acknowledgement frames+(2L+1) SIFSs.

L is a number of block acknowledgement request trigger frames sent by the access point.

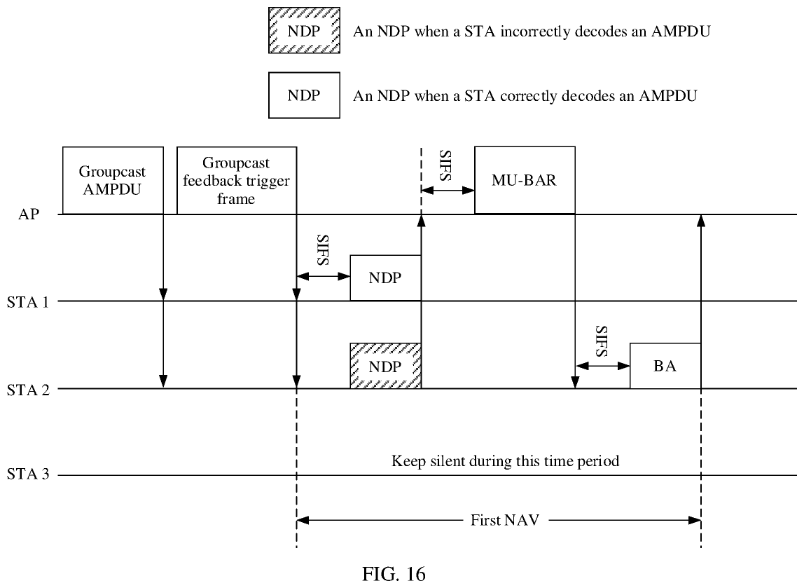

For example, as shown in FIG. 16, that the groupcast data frame is the AMPDU, STAs in the groupcast group include the STA 1 and the STA 2, and there is a non-groupcast station STA 3 in the coverage area of the AP are used as an example. After sending the AMPDU, the AP sends the groupcast feedback trigger frame, and the groupcast feedback trigger frame indicates the first NAV. The STA 1 and the STA 2 are scheduled by the AP to send groupcast feedback report frames (represented by NDPs in FIG. 16) in the first NAV. If the STA 2 incorrectly decodes the AMPDU, the AP sends the block acknowledgement request trigger frame, to schedule the STA 2 to feed back the block acknowledgement frame. After receiving the block acknowledgement request trigger frame, the STA 2 is scheduled by the AP to send the block acknowledgement frame, to indicate the incorrectly decoded MPDU, and the STA 3 keeps silent in the first NAV.

Based on this solution, the access point can indicate the first NAV in the groupcast feedback trigger frame, to protect a channel in a feedback procedure. This reduces interference of a non-groupcast station to the feedback procedure, improves feedback efficiency, and reduces a feedback delay. In this way, the access point can timely retransmit an incorrect MPDU to reduce a groupcast service delay, or can timely adjust a transmission rate to improve a groupcast service transmission rate.

In addition to the groupcast feedback method described above, this application further provides a groupcast feedback method. In this method, in a scenario where an access point selects a proper MCS and controls a PER of a single transmission within a specific range to ensure that only a few groupcast STAs incorrectly perform decoding, through UL OFDMA-based random access, namely, a UORA idea, at least one RU is pre-allocated and is used by a groupcast STA that incorrectly decodes the groupcast data frame, to feed back information about incorrect decoding.

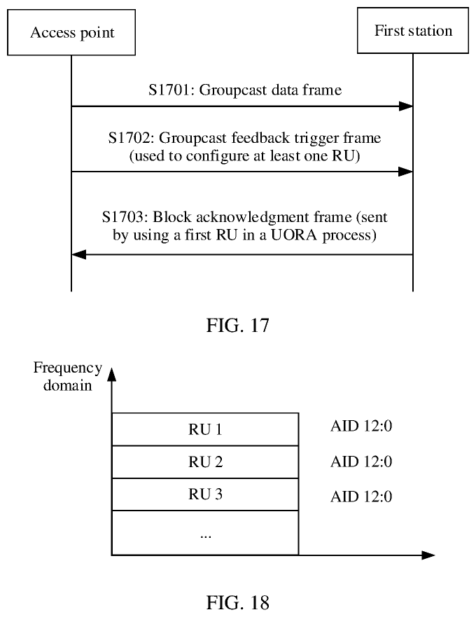

Specifically, refer to FIG. 17. The multicast feedback method includes the following steps.

S1701: The access point sends the groupcast data frame. Correspondingly, a first station receives the groupcast data frame from the access point.

The first station is any one of a plurality of stations in the groupcast group.

In some embodiments, the groupcast data frame includes a plurality of data frames. For example, the groupcast data frame is an AMPDU, and the data frames forming the groupcast data frame are a plurality of MPDUs.

In some other embodiments, the groupcast data frame includes only one data frame. For example, the data frame is the MPDU, and the groupcast data frame includes only one MPDU, or the groupcast data frame is the MPDU.

For specific details of step S1701, refer to related descriptions of the step S1001. Details are not described herein again.

S1702: The access point sends a groupcast feedback trigger frame. Correspondingly, the first station receives the groupcast feedback trigger frame from the access point.

The groupcast feedback trigger frame is used to configure the at least one RU. The RU is used by the station in the groupcast group to transmit a block acknowledgement frame of the groupcast data frame in a UORA process. The block acknowledgement frame of the groupcast data frame is used to indicate an incorrectly decoded data frame in the groupcast data frame.

In some embodiments, the “groupcast feedback trigger frame” in the method shown in FIG. 17 may also be referred to as an “uplink OFDMA-based random access-negative acknowledgement poll trigger (UORA-NACK Poll Trigger) frame”, and the two may be replaced with each other. This is not specifically limited in this application.

In some embodiments, the groupcast feedback trigger frame may include at least one user information field (user info field, UIF), each user information field is used to configure one RU, and a plurality of UIFs are allowed to configure a plurality of consecutive RUs whose sizes are the same. In addition, each UIF includes one “AID 12” field, and the “AID 12” field is set to 0, indicating that an RU currently configured by the UIF is an RU allocated to a STA associated with the AP.

For example, the groupcast feedback trigger frame includes three UIFs, and the three UIFs respectively configure an RU 1, an RU 2, and an RU 3. In this case, a schematic diagram of setting of the “AID 12” field in the UIF and distribution of the RUs may be shown in FIG. 18.

In some embodiments, the groupcast feedback trigger frame includes a first field. When a value of the first field is a first value, it indicates that a type of the groupcast feedback trigger frame is currently uplink orthogonal frequency division multiple access-based random access-negative acknowledgement poll, namely, UORA-NACK Poll.

In some embodiments, the groupcast feedback trigger frame may be a newly defined MU-BAR trigger frame, including a BAR control field, and the first field may be a BAR type field in the BAR control field.

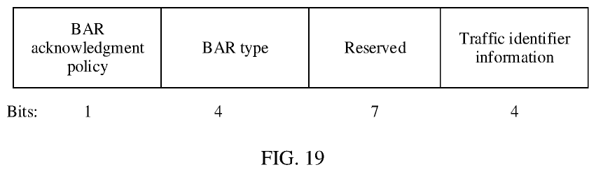

For example, a format of the BAR control field may be shown in FIG. 19, and includes a 1-bit BAR acknowledgement policy (BAR ACK Policy) field, a 4-bit BAR type (BAR Type) field, a 7-bit reserved (Reserved) field, and 4-bit traffic identifier information (TID_INFO) field. TID indicates a traffic identifier (TID).

The BAR acknowledgement policy (BAR ACK Policy) field indicates whether a transmit end requires a receive end to perform an immediate acknowledgement feedback. When a value is 1, it indicates that the transmit end needs to perform the immediate acknowledgement feedback, and when a value is 0, it indicates that the transmit end does not need to perform the immediate acknowledgement feedback. A function of the traffic identifier information (TID_INFO) field is related to a type of a BAR frame. For specific descriptions, refer to related descriptions in the 802.11ax standard. Details are not described herein again. The BAR type field indicates a type of the MU-BAR trigger frame currently. Further, the first value may be any one of 0, 4, 5, or 7 to 9. For example, the first value is equal to 0. A value of the BAR type field and a corresponding feedback type are shown in Table 2.

TABLE 2

| BAR | | |
|---|---|---|
| type field | BAR frame type | Description |
| 0 | UORA-NACK | Used by incorrectly decoded groupcast |
| | Poll | STAs to feed back a BA. |
| 1 | Extended | Refer to descriptions in the 802.11ax |
| | compressed | standard. |
| 2 | Compressed | Refer to descriptions in the 802.11ax |
| | | standard. |
| 3 | Multicast traffic | Refer to descriptions in the 802.11ax |
| | identifier | standard. |
| | (Multi-TID) | |
| 4-5 | Reserved | |
| 6 | Groupcast with | Used to schedule specific groupcast |
| | retries (GCR) | STAs to feed back a BA. |
| 7-9 | Reserved | |
| 10 | GLK-GCR | Refer to descriptions in the 802.11ax |
| | | standard. |
| 11-15 | Reserved | |

In other words, in this application, a BAR type field of an MMU-BAR trigger frame may be reused, and a reserved value of the BAR type field in the 802.11ax standard may be used to indicate uplink orthogonal frequency division multiple access-based random access-negative acknowledgement poll.

In some embodiments, the groupcast feedback trigger frame may be a newly defined basic trigger frame. A form of the groupcast feedback trigger frame is not specifically limited in this application.

After the first station receives the groupcast feedback trigger frame, if the first station incorrectly decodes the groupcast data frame, the first station performs the following step S1703.

It should be understood that a station that incorrectly decodes the groupcast data frame in the groupcast group has a same or similar processing action, and may perform a function or an action implemented by the first station provided in the following embodiment of this application.

S1703: The first station sends, by using a first RU in the UORA process, the block acknowledgement frame BA of the groupcast data frame to the access point. Correspondingly, the access point receives the BA from the first station by using the first RU in the UORA process.

The first RU is one of the at least one RU configured by the groupcast feedback trigger frame. The block acknowledgement frame is used to indicate a data frame that is in the groupcast data frame and that is incorrectly decoded by the first station.

In an example, the block acknowledgement frame may include a block acknowledgement bitmap (Block ACK Bitmap), that is, a bitmap is used to indicate the incorrectly decoded data frame in the groupcast data frame. Refer to related descriptions in the foregoing step S1007. Details are not described herein again.

In some embodiments, that the first station sends, by using the first RU in the UORA process, the block acknowledgement frame of the groupcast data frame to the access point may include: The first station selects a random number from a contention window. When the random number is less than or equal to a total number of the at least one RU configured by the groupcast feedback trigger frame, the first station selects the first RU from the at least one RU, and then sends, on the first RU, the block acknowledgement frame of the groupcast data frame to the access point.

Based on this solution, in one aspect, the access point preconfigures the at least one RU that is configured to feed back a block acknowledgement frame of a groupcast STA that incorrectly performs decoding, to obtain a transmission status of the groupcast data frame. In this way, the access point can retransmit an incorrectly decoded data frame in the groupcast data frame to improve transmission reliability, or adjust a link transmission rate to improve transmission efficiency. In another aspect, in this application, only a block acknowledgement frame of the groupcast STA that incorrectly performs decoding is fed back, and a block acknowledgement frame of a groupcast STA that correctly performs decoding may not be fed back. This can reduce transmission overheads of a control frame, compared with a solution according to a conventional GCR MU-BAR feedback method defined in the 802.11ax standard, in which the block acknowledgement frame of the groupcast STA that correctly performs decoding is also fed back.

In some embodiments, a plurality of stations in the groupcast group may incorrectly decode the groupcast data frame, and the plurality of stations may select a same RU to send the block acknowledgement frame, resulting a feedback conflict. Then, the access point cannot correctly collect feedback information. In this scenario, when the access point cannot correctly decode the block acknowledgement frame fed back by the groupcast STA, the access point may send a NACK frame, to notify a STA that is in the groupcast group and that incorrectly decodes the groupcast data frame to retransmit the block acknowledgement frame.

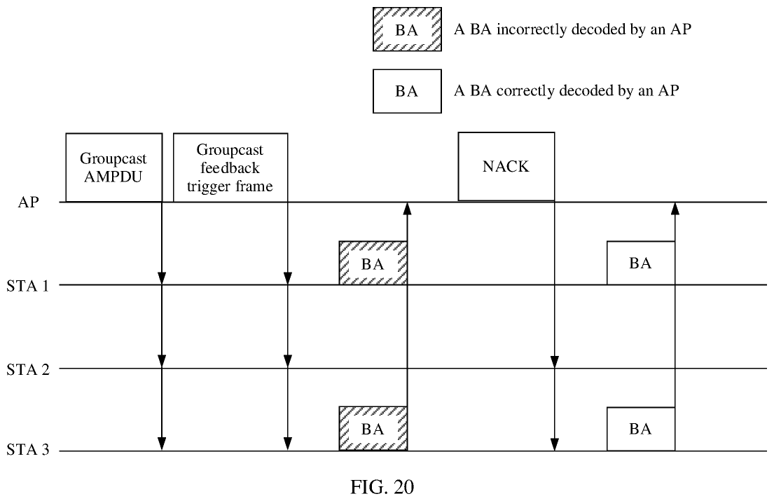

For example, as shown in FIG. 20, STAs in the groupcast group include a STA 1, a STA 2, and a STA 3. The STA 2 correctly decodes the groupcast data frame, and the STA 1 and the STA 3 incorrectly decode the groupcast data frame. After sending the AMPDU, the AP sends the groupcast feedback trigger frame. After receiving the groupcast feedback trigger frame, the STA 1 and the STA 3 separately select an RU from RUs configured by the groupcast feedback trigger frame to send the block acknowledgement frame. It is assumed that the RUs selected by the STA 1 and the STA 3 are the same, and the access point cannot correctly decode the block acknowledgement frames fed back by the STA 1 and the STA 3. The access point sends the NACK frame. After receiving the NACK frame, the STA 1 and the STA 3 reselect an RU and retransmit the block acknowledgement frame on the reselected RU.

Based on this solution, when block acknowledgement frames sent by a plurality of groupcast stations collide, the access point may indicate the plurality of groupcast stations to retransmit the block acknowledgement frames, so as to ensure that the access point correctly decodes the block acknowledgement frames, obtains a transmission status of the groupcast data frame, and further performs retransmission or rate adjustment according to the transmission status.

In embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

It may be understood that, in the foregoing embodiments, methods and/or steps implemented by the access point may also be implemented by a component (for example, a chip or a circuit) that can be used in the access point, and methods and/or steps implemented by the station may also be implemented by a component (for example, a chip or a circuit) that can be used in the station.

The foregoing mainly describes the solutions provided in this application from the perspective of interaction between devices. Correspondingly, this application further provides a communication apparatus. The communication apparatus is configured to implement the foregoing methods. The communication apparatus may be the access point in the foregoing method embodiments, an apparatus including the foregoing access point, or a component that can be used in the access point. Alternatively, the communication apparatus may be the first station in the foregoing method embodiments, an apparatus including the foregoing first station, or a component that can be used in the first station.

It may be understood that, to implement the foregoing functions, the communication apparatus includes a hardware structure and/or a software module for performing a corresponding function. A person skilled in the art should be easily aware that, with reference to units and algorithm steps in the examples described in embodiments disclosed in this specification, this application can be implemented in a form of hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, the communication apparatus may be divided into functional modules based on the foregoing method embodiments. For example, each functional module may be obtained through division based on each corresponding function, or two or more functions may be integrated into one processing module. The integrated module may be implemented in a form of hardware, or may be implemented in a form of a software functional module. It should be noted that, in embodiments of this application, module division is an example, and is merely a logical function division. In actual implementation, another division manner may be used.

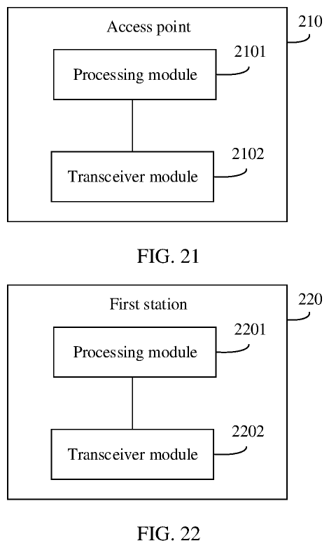

In an implementation scenario, for example, the communication apparatus is the access point in the foregoing method embodiments. FIG. 21 is a schematic diagram of a structure of an access point 210. The access point 210 includes a processing module 2101 and a transceiver module 2102.

In some embodiments, the access point 210 may further include a storage module (not shown in FIG. 21), configured to store program instructions and data.

In some embodiments, the transceiver module 2102 may also be referred to as a transceiver unit, and is configured to implement a sending function and/or a receiving function. The transceiver module 2102 may include a transceiver circuit, a transceiver machine, a transceiver, or a communication interface.

In some embodiments, the transceiver module 2102 may include a receiving module and a sending module, respectively configured to perform receiving and sending steps performed by the access point in the foregoing method embodiments, and/or another process configured to support the technology described in this specification. The processing module 2101 may be configured to perform processing steps (for example, determining and obtaining) performed by the access point in the foregoing method embodiments, and/or another process configured to support the technology described in this specification.

In an implementation scenario, the transceiver module 2102 is configured to send a groupcast data frame and a groupcast feedback trigger frame. The groupcast feedback trigger frame is used to schedule a plurality of stations in a groupcast group to indicate whether the groupcast data frame is correctly decoded. The processing module 2101 is configured to determine, when detecting no energy on a first subcarrier and a second subcarrier, that a first station incorrectly decodes the groupcast data frame. Alternatively, the processing module 2101 is configured to determine, when detecting energy on a second subcarrier, that a first station incorrectly decodes the groupcast data frame.

The first subcarrier is a subcarrier associated with the first station in a first subcarrier set. The second subcarrier is a subcarrier associated with the first station in a second subcarrier set. The first station is any one of the plurality of stations.

In a possible implementation, the transceiver module 2102 is further configured to send a block acknowledgement request trigger frame. The block acknowledgement request trigger frame is used to schedule at least one second station to feed back, on a resource unit RU associated with the at least one second station, a sequence number index of an incorrectly decoded media access control protocol data unit MPDU in an AMPDU. The second station is a station in the plurality of stations that incorrectly decodes the AMPDU. The transceiver module 2102 is further configured to receive, on the RU associated with the at least one second station, a block acknowledgement frame from the at least one second station. The block acknowledgement frame is used to indicate an incorrectly decoded MPDU in the AMPDU.

In a possible implementation, the groupcast feedback trigger frame includes a third field. The third field indicates a first network allocation vector NAV. Duration of the first NAV is a sum of a plurality of items: duration of the groupcast feedback report frame, duration of the block acknowledgement request trigger frame, duration of the block acknowledgement frame, and a short interframe space SIFS. The groupcast feedback report frame is a response frame of the groupcast feedback trigger frame.

In a possible implementation, the groupcast feedback trigger frame includes a third field. The third field indicates a first network allocation vector NAV Duration of the first NAV is a sum of duration of the groupcast feedback report frame and a short interframe space SIFS. The groupcast feedback report frame is a response frame of the groupcast feedback trigger frame.

In a possible implementation, the groupcast feedback trigger frame includes a first field. When a value of the first field is a first value, it indicates that a type of the groupcast feedback trigger frame is a groupcast with retries acknowledgement request.

In a possible implementation, the groupcast feedback trigger frame includes a second field, and the second field indicates the groupcast data frame.

In a possible implementation, the second field includes a first subfield and a second subfield. The first subfield is used to carry a sequence number index of a start data frame in the groupcast data frame. The second subfield is used to carry a sequence number index of an end data frame in the groupcast data frame.

In another implementation scenario, the processing module 2101 is configured to generate a groupcast data frame and a groupcast feedback trigger frame. The transceiver module 2102 is configured to send the groupcast data frame and the groupcast feedback trigger frame. The groupcast feedback trigger frame is used to configure at least one resource unit RU. The RU is used by a station in a groupcast group to transmit a block acknowledgement frame of the groupcast data frame in an uplink orthogonal frequency division multiple access-based random access UORA process. The transceiver module 2102 is further configured to receive, by using a first RU in the UORA process, the block acknowledgement frame from a first station. The block acknowledgement frame is used to indicate an incorrectly decoded data frame in the groupcast data frame. The first RU is one of the at least one RU configured by the groupcast feedback trigger frame.

In a possible implementation, the groupcast data frame is an aggregate-media access control protocol data unit AMPDU, and a data frame is a media access control protocol data unit MPDU.

In a possible implementation, the groupcast feedback trigger frame includes a first field. When a value of the first field is a first value, it indicates that a type of the groupcast feedback trigger frame is uplink orthogonal frequency division multiple access-based random access-negative acknowledgement poll.

All related content of the steps in the foregoing method embodiments may be cited in function descriptions of corresponding functional modules. Details are not described herein again.

In this application, the access point 210 is presented in a form of obtaining each function module through division in an integrated manner. The “module” herein may be an application-specific integrated circuit (ASIC), a circuit, a processor and a memory that execute one or more software or firmware programs, an integrated logic circuit, and/or another device that can provide the foregoing functions.

In some embodiments, in terms of hardware implementation, a person skilled in the art may figure out that the access point 210 may be in a form of the WLAN device 300 shown in FIG. 3.

In an example, the processor 301 in the WLAN device 300 shown in FIG. 3 may invoke computer-executable instructions stored in the memory 304, to implement functions/implementation processes of the processing module 2101 in FIG. 21, and the transceiver 302 in the WLAN device 300 shown in FIG. 3 may implement functions/implementation processes of the transceiver module 2102 in FIG. 21.

In some embodiments, when the access point 210 in FIG. 21 is a chip or a chip system, a function/implementation process of the processing module 2101 may be implemented by using an input/output interface (or a communication interface) of the chip or the chip system, and a function/implementation process of the transceiver module 2102 may be implemented by using a processor (or a processing circuit) of the chip or the chip system.

Because the access point 210 provided in this embodiment may perform the foregoing groupcast feedback method, for technical effect that can be achieved by the access point, refer to the foregoing method embodiments. Details are not described herein again.

In an implementation scenario, for example, the communication apparatus is the first station in the foregoing method embodiments. FIG. 22 is a schematic diagram of a structure of a first station 220. The first station 220 includes a processing module 2201 and a transceiver module 2202.

In some embodiments, the first station 220 may further include a storage module (not shown in FIG. 22), configured to store program instructions and data.

In some embodiments, the transceiver module 2202 may also be referred to as a transceiver unit, and is configured to implement a sending function and/or a receiving function. The transceiver module 2202 may include a transceiver circuit, a transceiver machine, a transceiver, or a communication interface.

In some embodiments, the transceiver module 2202 may include a receiving module and a sending module, respectively configured to perform receiving and sending steps performed by the first station in the foregoing method embodiments, and/or another process configured to support the technology described in this specification. The processing module 2201 may be configured to perform processing steps (for example, determining and obtaining) performed by the first station in the foregoing method embodiments, and/or another process configured to support the technology described in this specification.

In an implementation scenario, the transceiver module 2202 is configured to receive a groupcast data frame and a groupcast feedback trigger frame from an access point. The groupcast feedback trigger frame is used to schedule a plurality of stations in a groupcast group to indicate whether the groupcast data frame is correctly decoded. The transceiver module 2202 is further configured to send a groupcast feedback report frame to the access point on a second subcarrier when the processing module 2201 determines that the plurality of stations include the first station and the first station incorrectly decodes the groupcast data frame. The second subcarrier is a subcarrier associated with the first station in a second subcarrier set.

In a possible implementation, the transceiver module 2202 is further configured to receive a block acknowledgement request trigger frame from the access point. The block acknowledgement request trigger frame is used to schedule the first station to feed back, on a resource unit RU associated with the first station, a sequence number index of an incorrectly decoded media access control protocol data unit MPDU in an AMPDU. The transceiver module 2202 is further configured to send a block acknowledgement frame to the access point on the RU associated with the first station. The block acknowledgement frame is used to indicate the incorrectly decoded MPDU in the AMPDU.

In a possible implementation, the groupcast feedback trigger frame includes a third field. The third field indicates a first network allocation vector NAV Duration of the first NAV is a sum of a plurality of items: duration of the groupcast feedback report frame, duration of the block acknowledgement request trigger frame, duration of the block acknowledgement frame, and a short interframe space SIFS. The groupcast feedback report frame is a response frame of the groupcast feedback trigger frame.

In a possible implementation, the groupcast feedback trigger frame includes a third field. The third field indicates a first network allocation vector NAV Duration of the first NAV is a sum of duration of the groupcast feedback report frame and a short interframe space SIFS. The groupcast feedback report frame is a response frame of the groupcast feedback trigger frame.

In a possible implementation, the groupcast feedback trigger frame includes a first field. When a value of the first field is a first value, it indicates that a type of the groupcast feedback trigger frame is a groupcast with retries acknowledgement request.

In a possible implementation, the groupcast feedback trigger frame includes a second field, and the second field indicates the groupcast data frame.

In a possible implementation, the second field includes a first subfield and a second subfield. The first subfield is used to carry a sequence number index of a start data frame in the groupcast data frame. The second subfield is used to carry a sequence number index of an end data frame in the groupcast data frame.

In another implementation scenario, the transceiver module 2202 is configured to receive a groupcast data frame and a groupcast feedback trigger frame from an access point. The groupcast feedback trigger frame is used to configure at least one resource unit RU. The RU is used by a station in a groupcast group to perform uplink orthogonal frequency division multiple access-based random access UORA. The UORA is used to transmit a block acknowledgement frame of the groupcast data frame. The transceiver module 2202 is configured to send, by using a first RU in the UORA process, the block acknowledgement frame of the groupcast data frame to the access point when the processing module 2201 incorrectly decodes the groupcast data frame. The block acknowledgement frame is used to indicate an incorrectly decoded data frame in the groupcast data frame. The first RU is one of the at least one RU configured by the groupcast feedback trigger frame.

In a possible implementation, the processing module 2201 is configured to select a random number from a contention window. When the random number is less than or equal to a total number of the at least one RU configured by the groupcast feedback trigger frame, the processing module selects the first RU from the at least one RU. The transceiver module 2202 is configured to send, on the first RU, the block acknowledgement frame of the groupcast data frame to the access point.

In a possible implementation, the groupcast data frame is an aggregate-media access control protocol data unit AMPDU, and a data frame is a media access control protocol data unit MPDU.

In a possible implementation, the groupcast feedback trigger frame includes a first field. When a value of the first field is a first value, it indicates that a type of the groupcast feedback trigger frame is uplink orthogonal frequency division multiple access-based random access-negative acknowledgement poll.

All related content of the steps in the foregoing method embodiments may be cited in function descriptions of corresponding functional modules. Details are not described herein again.

In this application, the first station 220 is presented in a form of obtaining each function module through division in an integrated manner. The “module” herein may be an application-specific integrated circuit (ASIC), a circuit, a processor and a memory that execute one or more software or firmware programs, an integrated logic circuit, and/or another device that can provide the foregoing functions.

In some embodiments, in terms of hardware implementation, a person skilled in the art may figure out that the first station 220 may be in a form of the WLAN device 300 shown in FIG. 3.

In an example, the processor 301 in the WLAN device 300 shown in FIG. 3 may invoke computer-executable instructions stored in the memory 304, to implement functions/implementation processes of the processing module 2201 in FIG. 22, and the transceiver 302 in the WLAN device 300 shown in FIG. 3 may implement functions/implementation processes of the transceiver module 2202 in FIG. 22.

In some embodiments, when the first station 220 in FIG. 22 is a chip or a chip system, a function/implementation process of the processing module 2201 may be implemented by using an input/output interface (or a communication interface) of the chip or the chip system, and a function/implementation process of the transceiver module 2202 may be implemented by using a processor (or a processing circuit) of the chip or the chip system.

Because the first station 220 provided in this embodiment may perform the foregoing groupcast feedback method, for technical effect that can be achieved by the first station, refer to the foregoing method embodiments. Details are not described herein again.

In a possible product form, the access point and the first station in embodiments of this application may alternatively be implemented by using the following: one or more field programmable gate arrays (FPGAs), a programmable logic device (PLD), a controller, a state machine, a logic gate, a discrete hardware component, any other suitable circuit, or any combination of circuits that can perform various functions described in this application.

In some embodiments, an embodiment of this application further provides a communication apparatus. The communication apparatus includes a processor, configured to implement the method in any one of the foregoing method embodiments.

In a possible implementation, the communication apparatus further includes a memory. The memory is configured to store necessary program instructions and necessary data. The processor may invoke program code stored in the memory, to indicate the communication apparatus to perform the method in any one of the foregoing method embodiments. Certainly, the communication apparatus may not include a memory.

In another possible implementation, the communication apparatus further includes an interface circuit. The interface circuit is a code/data read/write interface circuit, and the interface circuit is configured to receive computer-executable instructions (where the computer-executable instructions are stored in a memory, and may be directly read from the memory, or may be read via another component) and transmit the computer-executable instructions to the processor.

In still another possible implementation, the communication apparatus further includes a communication interface, and the communication interface is configured to communicate with a module other than the communication apparatus.

It may be understood that the communication apparatus may be a chip or a chip system. When the communication apparatus is a chip system, the communication apparatus may include a chip, or may include a chip and another discrete component. This is not specifically limited in this embodiment of this application.

In some embodiments, an embodiment of this application further provides a communication apparatus (for example, the communication apparatus may be a chip or a chip system). The communication apparatus includes an interface circuit and a logic circuit. The interface circuit is configured to obtain input information and/or output information. The logic circuit is configured to perform the method in any one of the foregoing method embodiments, to process and/or generate the output information based on the input information.

The communication apparatus is used to implement the function of the access point in the foregoing method embodiments.

In some possible designs, the output information may be a groupcast data frame and a groupcast feedback trigger frame. The groupcast feedback trigger frame is used to schedule a plurality of stations in a groupcast group to indicate whether the groupcast data frame is correctly decoded.

In some possible designs, the input information may be a block acknowledgement frame of at least one second station, and the block acknowledgement frame is used to indicate an incorrectly decoded MPDU in an AMPDU. Correspondingly, performing processing based on the input information may be determining a retransmitted MPDU or modulating a transmission rate based on the block acknowledgement frame.

Alternatively, the communication apparatus is used to implement the function of the access point in the foregoing method embodiments.

In some possible designs, the output information may be a groupcast data frame and a groupcast feedback trigger frame. The groupcast feedback trigger frame is used to configure at least one resource unit RU. The RU is used by a station in a groupcast group to transmit a block acknowledgement frame of the groupcast data frame in an uplink orthogonal frequency division multiple access-based random access UORA process.

In some possible designs, the input information may be a block acknowledgement frame, and the block acknowledgement frame is used to indicate an incorrectly decoded data frame in a groupcast data frame. Correspondingly, performing processing based on the input information may be determining a retransmitted data frame or modulating a transmission rate based on the block acknowledgement frame.

The communication apparatus is used to implement the function of the first station in the foregoing method embodiments.

In some possible designs, the input information may be a groupcast data frame and a groupcast feedback trigger frame. The groupcast feedback trigger frame is used to schedule a plurality of stations in a groupcast group to indicate whether the groupcast data frame is correctly decoded. Correspondingly, performing processing based on the input information may be sending a groupcast feedback report frame to an access point on a second subcarrier when the plurality of stations scheduled by the groupcast feedback trigger frame in the groupcast group include a first station, and the first station incorrectly decodes the groupcast data frame. The second subcarrier is a subcarrier associated with the first station in a second subcarrier set.

In some possible designs, the output information may be a block acknowledgement frame, and the block acknowledgement frame is used to indicate an incorrectly decoded MPDU in an AMPDU.

Alternatively, the communication apparatus is used to implement the function of the first station in the foregoing method embodiments.

In some possible designs, the input information may be a groupcast data frame and a groupcast feedback trigger frame. The groupcast feedback trigger frame is used to configure at least one resource unit RU. The RU is used by a station in a groupcast group to transmit a block acknowledgement frame of the groupcast data frame in an uplink orthogonal frequency division multiple access-based random access UORA process. Correspondingly, performing processing based on the input information may be: when a first station incorrectly decodes the groupcast data frame, sending, by using a first RU, a block acknowledgement frame of the groupcast data frame to an access point in a UORA process. The block acknowledgement frame is used to indicate an incorrectly decoded data frame in the groupcast data frame. The first RU is one of the at least one RU configured by the groupcast feedback trigger frame.

In some possible designs, the output information may be a block acknowledgement frame, and the block acknowledgement frame is used to indicate an incorrectly decoded data frame in a groupcast data frame.

The communication apparatus provided in this embodiment may perform the method in the foregoing method embodiments. Therefore, for technical effect that can be achieved by the communication apparatus, refer to the foregoing method embodiments. Details are not described herein again.

In a possible product form, the access point and the first station in embodiments of this application may be implemented by using a general bus architecture.

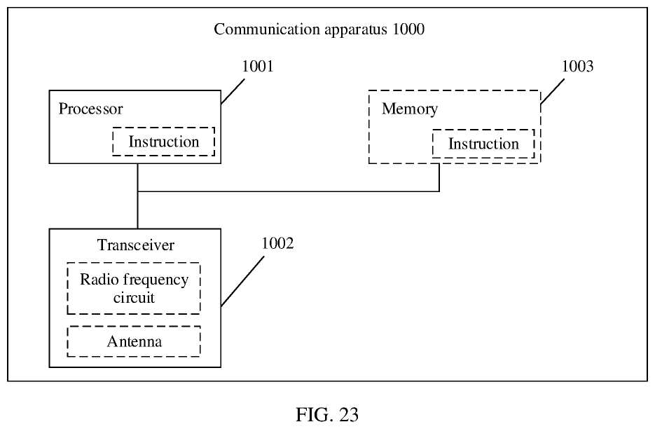

For ease of description, FIG. 23 is a schematic diagram of a structure of a communication apparatus 1000 according to an embodiment of this application. The communication apparatus 1000 includes a processor 1001 and a transceiver 1002. The communication apparatus 1000 may be an access point, a first station, or a chip thereof. FIG. 23 shows only main components of the communication apparatus 1000. In addition to the processor 1001 and the transceiver 1002, the communication apparatus may further include a memory 1003 and an input/output apparatus (not shown in the figure).

The processor 1001 is mainly configured to: process a communication protocol and communication data, control the entire communication apparatus, execute a software program, and process data of the software program. The memory 1003 is mainly configured to store the software program and the data. The transceiver 1002 may include a radio frequency circuit and an antenna. The radio frequency circuit is mainly configured to perform conversion between a baseband signal and a radio frequency signal and process the radio frequency signal. The antenna is mainly configured to receive and send a radio frequency signal in a form of an electromagnetic wave. The input/output apparatus, for example, a touchscreen, a display, or a keyboard, is mainly configured to receive data input by a user and output data to the user.

The processor 1001, the transceiver 1002, and the memory 1003 may be connected through a communication bus.

After the communication apparatus is powered on, the processor 1001 may read the software program in the memory 1003, interpret and execute instructions of the software program, and process the data of the software program. When data needs to be sent wirelessly, the processor 1001 performs baseband processing on the to-be-sent data, and then outputs a baseband signal to the radio frequency circuit. The radio frequency circuit performs radio frequency processing on the baseband signal, and then sends a radio frequency signal in an electromagnetic wave form through the antenna. When data is sent to the communication apparatus, the radio frequency circuit receives the radio frequency signal through the antenna, converts the radio frequency signal into a baseband signal, and outputs the baseband signal to the processor 1001. The processor 1001 converts the baseband signal into data, and processes the data.

In another implementation, the radio frequency circuit and the antenna may be disposed independent of the processor that performs baseband processing. For example, in a distributed scenario, the radio frequency circuit and the antenna may be disposed remotely and independent of the communication apparatus.

It should be understood that sequence numbers of the foregoing processes do not mean execution sequences in various embodiments of this application. The execution sequences of the processes should be determined based on functions and internal logic of the processes, but should not be construed as any limitation on the implementation processes in embodiments of this application.

The steps of the method in embodiments of this application may be adjusted in sequence, combined, or deleted based on an actual requirement.

The modules in the apparatus in embodiments of this application may be combined, divided, and deleted based on an actual requirement.

All or some of the foregoing embodiments may be implemented by using software, hardware, firmware, or any combination thereof. When a software program is used to implement embodiments, all or some of the embodiments may be implemented in a form of a computer program product. The computer program product includes one or more computer instructions. When the computer program instructions are loaded and executed on a computer, all or some of the procedures or functions in embodiments of this application are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk drive, or a magnetic tape), an optical medium (for example, a DVD), a semiconductor medium (for example, a solid state disk (SSD)), or the like. In embodiments of this application, the computer may include the apparatus described above.

Although this application is described with reference to embodiments, in a process of implementing this application that claims protection, a person skilled in the art may understand and implement another variation of the disclosed embodiments by viewing the accompanying drawings, disclosed content, and the appended claims. In the claims, “comprising” (comprising) does not exclude another component or another step, and “a” or “one” does not exclude a case of “a plurality of”. A single processor or another unit may implement several functions enumerated in the claims. Some measures are disclosed in dependent claims that are different from each other, but this does not mean that these measures cannot be combined to produce better effect.

Although this application is described with reference to specific features and embodiments thereof, it is clear that various modifications and combinations may be made to them without departing from the spirit and scope of this application. Correspondingly, the specification and accompanying drawings are merely example descriptions of this application defined by the appended claims, and are considered as any of or all modifications, variations, combinations, or equivalents that cover the scope of this application. It is clear that a person skilled in the art can make various modifications and variations to this application without departing from the spirit and scope of this application. This application is intended to cover these modifications and variations of this application provided that they fall within the scope of the claims of this application and equivalent technologies thereof.

What is claimed is:

1. A groupcast feedback method, wherein the method comprises:
sending, by an access point, a groupcast data frame;
sending, by the access point, a groupcast feedback trigger frame, wherein the groupcast feedback trigger frame is used to schedule a plurality of stations in a groupcast group to indicate whether the groupcast data frame is correctly decoded; and
determining, by the access point when detecting no energy on a first subcarrier and a second subcarrier, that a first station incorrectly decodes the groupcast data frame; or
determining, by the access point when detecting energy on a second subcarrier, that a first station incorrectly decodes the groupcast data frame, wherein
the first subcarrier is a subcarrier associated with the first station in a first subcarrier set, the second subcarrier is a subcarrier associated with the first station in a second subcarrier set, and the first station is any one of the plurality of stations.

2. The method according to claim 1, wherein when the groupcast data frame is an aggregate-media access control protocol data unit AMPDU, the method further comprises:
sending, by the access point, a block acknowledgement request trigger frame, wherein the block acknowledgement request trigger frame is used to schedule at least one second station to feed back, on a resource unit RU associated with the at least one second station, a sequence number index of an incorrectly decoded media access control protocol data unit MPDU in the AMPDU, and the second station is a station in the plurality of stations that incorrectly decodes the AMPDU; and
receiving, by the access point on the RU associated with the at least one second station, a block acknowledgement frame from the at least one second station, wherein the block acknowledgement frame is used to indicate the incorrectly decoded MPDU in the AMPDU.

3. The method according to claim 2, wherein the groupcast feedback trigger frame comprises a third field, the third field indicates a first network allocation vector NAV, duration of the first NAV is a sum of a plurality of items: duration of the groupcast feedback report frame, duration of the block acknowledgement request trigger frame, duration of the block acknowledgement frame, and a short interframe space SIFS, and the groupcast feedback report frame is a response frame of the groupcast feedback trigger frame.

4. The method according to claim 1, wherein the groupcast feedback trigger frame comprises a third field, the third field indicates a first network allocation vector NAV, duration of the first NAV is a sum of duration of the groupcast feedback report frame and a short interframe space SIFS, and the groupcast feedback report frame is a response frame of the groupcast feedback trigger frame.

5. The method according to claim 1, wherein the groupcast feedback trigger frame comprises a first field, and when a value of the first field is a first value, it indicates that a type of the groupcast feedback trigger frame is a groupcast with retries acknowledgement request.

6. The method according to claim 1, wherein the groupcast feedback trigger frame comprises a second field, and the second field indicates the groupcast data frame.

7. The method according to claim 6, wherein the second field comprises a first subfield and a second subfield, the first subfield is used to carry a sequence number index of a start data frame in the groupcast data frame, and the second subfield is used to carry a sequence number index of an end data frame in the groupcast data frame.

8. A groupcast feedback method, wherein the method comprises:
receiving, by a first station, a groupcast data frame from an access point;
receiving, by the first station, a groupcast feedback trigger frame from the access point, wherein the groupcast feedback trigger frame is used to schedule a plurality of stations in a groupcast group to indicate whether the groupcast data frame is correctly decoded; and
when the plurality of stations comprise the first station, and the first station incorrectly decodes the groupcast data frame, sending, by the first station on a second subcarrier, a groupcast feedback report frame to the access point, wherein the second subcarrier is a subcarrier associated with the first station in a second subcarrier set.

9. The method according to claim 8, wherein when the groupcast data frame is an aggregate-media access control protocol data unit AMPDU, the method further comprises:
receiving, by the first station, a block acknowledgement request trigger frame from the access point, wherein the block acknowledgement request trigger frame is used to schedule the first station to feed back, on a resource unit RU associated with the first station, a sequence number index of an incorrectly decoded media access control protocol data unit MPDU in the AMPDU; and
sending, by the first station on the RU associated with the first station, a block acknowledgement frame to the access point, wherein the block acknowledgement frame is used to indicate the incorrectly decoded MPDU in the AMPDU.

10. The method according to claim 9, wherein the groupcast feedback trigger frame comprises a third field, the third field indicates a first network allocation vector NAV, duration of the first NAV is a sum of a plurality of items: duration of the groupcast feedback report frame, duration of the block acknowledgement request trigger frame, duration of the block acknowledgement frame, and a short interframe space SIFS, and the groupcast feedback report frame is a response frame of the groupcast feedback trigger frame.

11. The method according to claim 8, wherein the groupcast feedback trigger frame comprises a third field, the third field indicates a first network allocation vector NAV, duration of the first NAV is a sum of duration of the groupcast feedback report frame and a short interframe space SIFS, and the groupcast feedback report frame is a response frame of the groupcast feedback trigger frame.

12. The method according to claim 8, wherein the groupcast feedback trigger frame comprises a first field, and when a value of the first field is a first value, it indicates that a type of the groupcast feedback trigger frame is a groupcast with retries acknowledgement request.

13. The method according to claim 8, wherein the groupcast feedback trigger frame comprises a second field, and the second field indicates the groupcast data frame.

14. The method according to claim 13, wherein the second field comprises a first subfield and a second subfield, the first subfield is used to carry a sequence number index of a start data frame in the groupcast data frame, and the second subfield is used to carry a sequence number index of an end data frame in the groupcast data frame.

15. A communication apparatus, wherein the communication apparatus comprises a processing module and a transceiver module, wherein
the transceiver module is configured to send a groupcast data frame;
the transceiver module is further configured to send a groupcast feedback trigger frame, wherein the groupcast feedback trigger frame is used to schedule a plurality of stations in a groupcast group to indicate whether the groupcast data frame is correctly decoded; and
the processing module is configured to determine, when detecting no energy on a first subcarrier and a second subcarrier, that a first station incorrectly decodes the groupcast data frame; or
the processing module is configured to determine, when detecting energy on a second subcarrier, that a first station incorrectly decodes the groupcast data frame, wherein
the first subcarrier is a subcarrier associated with the first station in a first subcarrier set, the second subcarrier is a subcarrier associated with the first station in a second subcarrier set, and the first station is any one of the plurality of stations.

16. The communication apparatus according to claim 15, wherein when the groupcast data frame is an aggregate-media access control protocol data unit AMPDU,
the transceiver module is further configured to send a block acknowledgement request trigger frame, wherein the block acknowledgement request trigger frame is used to schedule at least one second station to feed back, on a resource unit RU associated with the at least one second station, a sequence number index of an incorrectly decoded media access control protocol data unit MPDU in the AMPDU, and the second station is a station in the plurality of stations that incorrectly decodes the AMPDU; and
the transceiver module is further configured to receive, on the RU associated with the at least one second station, a block acknowledgement frame from the at least one second station, wherein the block acknowledgement frame is used to indicate the incorrectly decoded MPDU in the AMPDU.

17. The communication apparatus according to claim 16, wherein the groupcast feedback trigger frame comprises a third field, the third field indicates a first network allocation vector NAV, duration of the first NAV is a sum of a plurality of items: duration of the groupcast feedback report frame, duration of the block acknowledgement request trigger frame, duration of the block acknowledgement frame, and a short interframe space SIFS, and the groupcast feedback report frame is a response frame of the groupcast feedback trigger frame.

18. A communication apparatus, wherein the communication apparatus comprises a processing module and a transceiver module, wherein
the transceiver module is configured to receive a groupcast data frame from an access point;
the transceiver module is further configured to receive a groupcast feedback trigger frame from the access point, wherein the groupcast feedback trigger frame is used to schedule a plurality of stations in a groupcast group to indicate whether the groupcast data frame is correctly decoded; and
the transceiver module is further configured to send a groupcast feedback report frame to the access point on a second subcarrier when the processing module determines that the plurality of stations comprise the communication apparatus and the communication apparatus incorrectly decodes the groupcast data frame, wherein the second subcarrier is a subcarrier associated with the communication apparatus in a second subcarrier set.

19. The communication apparatus according to claim 18, wherein when the groupcast data frame is an aggregate-media access control protocol data unit AMPDU,
the transceiver module is further configured to receive a block acknowledgement request trigger frame from the access point, wherein the block acknowledgement request trigger frame is used to schedule the communication apparatus to feed back, on a resource unit RU associated with the communication apparatus, a sequence number index of an incorrectly decoded media access control protocol data unit MPDU in the AMPDU; and
the transceiver module is further configured to send a block acknowledgement frame to the access point on the RU associated with the communication apparatus, wherein the block acknowledgement frame is used to indicate the incorrectly decoded MPDU in the AMPDU.

20. The communication apparatus according to claim 19, wherein the groupcast feedback trigger frame comprises a third field, the third field indicates a first network allocation vector NAV, duration of the first NAV is a sum of a plurality of items: duration of the groupcast feedback report frame, duration of the block acknowledgement request trigger frame, duration of the block acknowledgement frame, and a short interframe space SIFS, and the groupcast feedback report frame is a response frame of the groupcast feedback trigger frame.
